(19) United States
(12) Patent Application Publication
(10) Pub. No.: US 2025/0371816 A1
(43) Pub. Date: Dec. 4, 2025

(54) AUGMENTED REALITY FOR A CONSTRUCTION SITE WITH MULTIPLE DEVICES

(71) Applicant: XYZ REALITY LIMITED, London (GB)

(72) Inventors: David MITCHELL, London (GB); Kazimali KHAKI, London (GB); Umar AHMED, London (GB)

(73) Assignee: XYZ REALITY LIMITED, London (GB)

(21) Appl. No.: 18/875,782

(22) PCT Filed: Jun. 16, 2023
(86) PCT No.: PCT/EP2023/066257

§ 371 Date: Dec. 17, 2024

(30) Foreign Application Priority Data
Jun. 24, 2022 (GB) GB2209274.6

(51) Int. Cl. G06T 19/00; G01C 15/00; G02B 27/00

(52) U.S. Cl. CPC G06T 19/006; G01C 15/002; G02B 27/0093

(57) ABSTRACT

Methods and systems for displaying augmented reality (AR) information at a construction site are described. These involve pro-viding a primary positioning device and at least one auxiliary AR headset at the construction site. The primary positioning device is tracked within the construction site using a positional tracking system and the at least one auxiliary AR headset is tracked relative to the primary positioning device. A relative pose of said auxiliary AR headset and a measured pose of the primary positioning device are used to determine a measured pose of said auxiliary AR headset within a coordinate system representing the construction site. The measured pose of at least the at least one auxiliary AR headset is used to display AR information via said auxiliary AR head-set.

### TECHNICAL BACKGROUND

Certain aspects of the present invention relate to displaying augmented reality (AR) information at a construction site. Certain preferred embodiments of the present invention use a primary positioning device and at least one auxiliary AR headset and may be extended to allow multiple users access to AR information while exploring the construction site. In certain cases, a primary AR headset is used to track a plurality of auxiliary AR headsets so as to display aligned BIM information on said auxiliary AR headsets.

### BACKGROUND OF THE INVENTION

Erecting a structure or constructing a building on a construction site is a lengthy process. The process can be summarised as follows. First, a three-dimensional (3D) model, known as a Building Information Model (BIM), is produced by a designer or architect. The BIM model is typically defined in real world coordinates. The BIM model is then sent to a construction site, most commonly in the form of two-dimensional (2D) drawings or, in some cases, as a 3D model on a computing device. An engineer, using a conventional stake out/set out device, establishes control points at known locations in the real-world coordinates on the site and uses the control points as a reference to mark out the location where each structure in the 2D drawings or BIM model is to be constructed. A builder then uses the drawings and/or BIM model in conjunction with the marks (“Set Out marks”) made by the engineer to erect the structure according to the drawings or model in the correct place. Finally, an engineer must validate the structure or task carried out. This can be performed using a 3D laser scanner to capture a point-cloud from which a 3D model of the “as built” structure can be derived automatically. The “as built” model is then manually compared to the original BIM model. This process can take up to two weeks, after which any items that are found to be out of tolerance must be reviewed and may give rise to a penalty or must be re-done.

The above method of erecting a structure or constructing a building on a construction site has a number of problems. Each task to be carried out at a construction site must be accurately set out in this way. Typically, setting out must be done several times during a project as successive phases of the work may erase temporary markers. Further, once a task has been completed at a construction site, it is generally necessary to validate the task or check it has been done at the correct location. Often the crew at a construction site need to correctly interpret and work from a set of 2D drawings created from the BIM. This can lead to discrepancies between the built structure and the original design. Also set control points are often defined in relation to each other, meaning that errors chaotically cascade throughout the construction site. Often these negative effects interact over multiple layers of contractors, resulting in projects that are neither on time, within budget nor to the correct specification.

WO2019/048866 A1 (also published as EP3679321), which is incorporated by reference herein, describes a headset for use in displaying a virtual image of a BIM in relation to a site coordinate system of a construction site. In one example, the headset comprises an article of headwear having one or more position-tracking sensors mounted thereon, augmented reality glasses incorporating at least one display, a display position tracking device for tracking movement of the display relative to at least one of the user's eyes and an electronic control system. The electronic control system is configured to convert a BIM defined in an extrinsic, real world coordinate system into an intrinsic coordinate system defined by a position tracking system, receive display position data from the display position device and headset tracking data from a headset tracking system and render a virtual image of the BIM relative to the position and orientation of the article of headwear on the construction site and relative position of the display relative to the user's eye and transmit the rendered virtual image to the display which is viewable by the user.

WO2019/048866 A1 describes methods of tracking a headset and/or a calibration tool using a common positional tracking system, such as a swept laser-beam system. WO2019/048866 A1 teaches that multiple users, such as members of a work crew at a construction site, may each be provided with a hard hat and augmented reality glasses as described therein. Each set of glasses may be calibrated using the same mathematical transformation and each user may be shown an individual virtual image of part of the BIM based on their respective position in the construction site as determined by the common positional tracking system.

US 2016/292918 A1, incorporated by reference herein, describes a method and system for projecting a model at a construction site using a network-coupled hard hat. Cameras are connected to the hard hat and capture an image of a set of registration markers. A position of the user device is determined from the image and an orientation is determined from motion sensors. A BIM is downloaded and projected to a removable visor based on the position and orientation. WO2019/048866 A1 and US 2016/292918 A1 teach different incompatible methods for displaying a BIM at a construction site. Typically, a user needs to choose a suitable one of these described systems for any implementation at a construction site.

The paper “Towards cloud Augmented Reality for construction application by BIM and SNS integration” by Yi Jiao et al describes a video-based on-line AR environment and a pilot cloud framework. An environment utilizing web3D is demonstrated, in which on-site images, e.g. as acquired using a tablet computer such as an iPad®, are rendered to box nodes and registered with virtual objects through a three-step method. A “cloud” system is also defined that comprises a federation of BIM and business social networking services (BSNS). The system described in the paper is not very accurate and registration of the BIM often needs to be corrected manually. Moreover, the web3D rendering, where an image captured from the tablet computer is mapped to the surface of a 3D object so as to allow composition with 3D BIM objects is not reliable or efficient for streaming views of a construction site.

WO 2020/092497 A2 describes a set of systems that can be used in construction settings to facilitate the tasks being performed. The location of projectors and augmented reality headsets can be calculated and used to determine what images to display to a worker, based on a map of work to be performed, such as a construction plan. Workers can use spatially-aware tools to make different locations be plumb, level, or equidistant with other locations. Power to tools can be disabled if they are near protected objects.

EP 3,936,819 A1 describes an augmented-reality system that is combined with a surveying system to make measurement and/or layout at a construction site more efficient. A reflector can be mounted to a wearable device having an augmented-reality system. A total station can be used to track a reflector, and truth can be transferred to the wearable device while an obstruction is between the total station and the reflector. Further, a target can be used to orient a local map of a wearable device to an environment based on a distance between the target and the wearable device.

Given the methods and devices of existing solutions, it is desired to lower a cost and/or technical complexity of providing AR imagery to multiple users at a construction site, e.g. within the given accuracy constraints of the construction application.

### SUMMARY OF THE INVENTION

Aspects of the present invention are set out in the appended independent claims. Variations of these aspects are set out in the appended dependent claims. Examples that are not claimed are also set out in the description below.

### BRIEF DESCRIPTION OF THE DRAWINGS

Examples of the invention will now be described, by way of example only, with reference to the accompanying drawings, in which:

FIG. 1A is a schematic illustration of an example AR system in use at a construction site with users having respective primary and auxiliary devices.

FIG. 1B is a schematic illustration showing how BIM data may be aligned with a view of the construction site.

FIG. 2A is schematic illustration showing, in perspective and from one side, an example hard hat incorporating an AR display that forms a primary device.

FIG. 2B is schematic illustration showing electronic components implementing an AR display module for the hard hat of FIG. 2A and an optional tracking module.

FIG. 2C is a schematic illustration showing, in perspective and from one side, a first example hard hat incorporating an AR display that forms an auxiliary device.

FIG. 2D is a schematic illustration showing, in perspective and from one side, a second example hard hat incorporating an AR display that forms an auxiliary device.

FIGS. 2E and 2F are schematic illustrations showing, in perspective and from one side, a third example with respective primary and auxiliary devices.

FIGS. 3A to 3C are schematic illustrations showing different arrangements for communications between AR devices at a construction site according to different examples.

FIG. 4 is a flow chart showing a method displaying AR information at a construction site according to an example.

### DETAILED DESCRIPTION

### Introduction

The present invention relates to improvements for the display of AR information, with specific application for the display of AR information to multiple users at a construction site. Example systems and methods are described that enable a work team with multiple members to view AR information at a construction site while reducing resource utilisation and cost. In particular examples, a primary positioning device, such as a hard hat and coupled AR headset is located within the construction site using a positional tracking system. The positional tracking system may be designed to provide high accuracy positioning data, such as a pose with millimetre accuracy. One or more auxiliary AR headsets are then provided that are located or tracked relative to the primary positioning device. These auxiliary AR headsets may be lower cost devices that omit sensor devices for the positional tracking system. By determining a position and orientation relative to the primary positioning device, high-accuracy positioning data for the primary positioning device may be used to determine corresponding positioning data for the auxiliary AR headsets. The subsequently computed positioning data for the auxiliary AR headsets may be defined within a coordinate system that is aligned with a coordinate system for AR information, such as at least a portion of the BIM. Hence, AR information may be displayed via the auxiliary AR headsets. This may then facilitate team inspections and lower the cost of providing a kit of multiple AR headsets.

The present invention extends the capabilities of the headset described in WO2019/048866 A1. For example, the primary positioning device may be based on the headset described in WO2019/048866 A1. However, in contrast to multiple users having headsets of the same design that are tracked by a high-accuracy positional tracking system, a primary positioning device may be adapted with sensors to determine the relative positions of other headsets that are not tracked with the high-accuracy positional tracking system. For example, other headsets may omit the sensor portions of the hard hat described in WO2019/048866 A1. These other headsets may thus be cheaper mass-produced AR headsets that are used with a conventional hard hat (i.e., without tracking sensors). Like WO2019/048866 A1, US 2016/292918 A1 does not consider in detail the dynamics of team inspections. It is assumed that each user wears the single device that is described.

The presently described examples may further enable the examples described in documents such as WO2019/048866 A1 and US 2016/292918 A1 to effectively scale over multiple users and to allow AR information display in areas that are outside a tracked volume for a high-accuracy positional tracking system. For example, tracking multiple headsets using the approaches described in either of WO2019/048866 A1 and US 2016/292918 A1 may lead to high computational demands and may face problems with occlusion or interference when multiple users are present within the construction site. Indeed, many off-the-shelf systems may not provide functionality to track multiple devices. In contrast, with the present examples, only the primary positioning device need be tracked with high accuracy, while the auxiliary AR headsets are tracked relative to the primary positioning device. This requires lower computational costs for the high-accuracy positional tracking system and effectively allows the primary positioning device to be a hub for the tracking of auxiliary devices. Those auxiliary devices may thus be positioned outside of a tracked volume for the primary positioning device. Further details and advantages will be apparent from the examples discussed below.

### Certain Term Definitions

Where applicable, terms used herein are to be defined as per the art. To ease interpretation of the following examples, explanations and definitions of certain specific terms are provided below.

The term “positional tracking system” is used to refer to a system of components for determining one or more of a location and orientation of an object within an environment. The terms “positioning system” and “tracking system” may be considered alternative terms to refer to a “positional tracking system”, where the term “tracking” refers to the repeated or iterative determining of one or more of location and orientation over time. A positional tracking system may be implemented using a single set of electronic components that are positioned upon an object to be tracked, e.g. a stand-alone system installed in the headset. In other cases, a single set of electronic components may be used that are positioned externally to the object. In certain cases, a positional tracking system may comprise a distributed system where a first set of electronic components is positioned upon an object to be tracked and a second set of electronic components is positioned externally to the object. These electronic components may comprise sensors and/or processing resources (such as cloud computing resources). A positional tracking system may comprise processing resources that may be implemented using one or more of an embedded processing device (e.g., upon or within the object) and an external processing device (e.g., a server computing device). Reference to data being received, processed and/or output by the positional tracking system may comprise a reference to data being received, processed and/or output by one or more components of the positioning system, which may not comprise all the components of the positional tracking system.

The term “pose” is used herein to refer to a location and orientation of an object. For example, a pose may comprise a coordinate specifying a location with reference to a coordinate system and a set of angles representing orientation of a point or plane associated with the object within the coordinate system. The point or plane may, for example, be aligned with a defined face of the object or a particular location on the object. In certain cases, an orientation may be specified as a normal vector or a set of angles with respect to defined orthogonal axes. In other cases, a pose may be defined by a plurality of coordinates specifying a respective plurality of locations with reference to the coordinate system, thus allowing an orientation of a rigid body encompassing the points to be determined. For a rigid object, the location may be defined with respect to a particular point on the object. A pose may specify the location and orientation of an object with regard to one or more degrees of freedom within the coordinate system. For example, an object may comprise a rigid body with three or six degrees of freedom. Three degrees of freedom may be defined in relation to translation with respect to each axis in 3D space, whereas six degrees of freedom may add a rotational component with respect to each axis. In other cases, three degrees of freedom may represent two orthogonal coordinates within a plane and an angle of rotation (e.g., [x, y, 0]). Six degrees of freedom may be defined by an [x, y, z, roll, pitch, yaw] vector, where the variables x, y, z represent a coordinate in a 3D coordinate system and the rotations are defined using a right-hand convention with respect to three axes, which may be the x, y and z axes. In examples herein relating to a headset, the pose may comprise the location and orientation of a defined point on the headset, or on an article of headwear that forms part of the headset, such as a centre point within the headwear calibrated based on the sensor positioning on the headwear. In certain cases, a pose of an object defined with reference to a centroid of that object may be transformed to a pose defined at another point in fixed relation to the centroid, e.g. a pose of a hard hat defined with respect to a central point within the hard hat may be mapped to a pose indicating a location and view direction for a set of coupled AR glasses. It should be noted that different coordinate systems may be used (e.g., using different basis functions as axes) to represent the same location and orientation information, where defined transformations may convert between different coordinate systems. For example, polar-coordinate systems may be used instead of cartesian-coordinate systems.

The term “coordinate system” is used herein to refer to a frame of reference, e.g. as used by each of a positional tracking system, a secondary headset tracking system, and a BIM. For example, a pose of an object may be defined within three-dimensional geometric space, where the three dimensions have corresponding orthogonal axes (typically x, y, z) within the geometric space. An origin may be defined for the coordinate system where lines defining the axes meet (typically, set as a zero point—(0, 0, 0)). Locations for a coordinate system may be defined as points within the geometric space that are referenced to unit measurements along each axis, e.g. values for x, y, and z representing a distance along each axis. In certain cases, quaternions may be used to represent at least an orientation, of an object such as a headset or camera within a coordinate system. In certain cases, dual quaternions allow positions and rotations to be represented. A dual quaternion may have 8 dimensions (i.e., comprise an array with 8 elements), while a normal quaternion may have 4 dimensions.

The terms “intrinsic” and “extrinsic” are used in certain examples to refer respectively to coordinate systems within a positional tracking system and coordinate systems outside of any one positional tracking system. For example, an extrinsic coordinate system may be a 3D coordinate system for the definition of an information model, such as a BIM, that is not associated directly with any one positioning system, whereas an intrinsic coordinate system may be a separate system for defining points and geometric structures relative to sensor devices for a particular positional tracking system.

Certain examples described herein use one or more transformations to convert between coordinate systems. The term “transformation” is used to refer to a mathematical operation that may be performed on one or points (or other geometric structures) within a first coordinate system to map those points to corresponding locations within a second coordinate system, or to map between points within the first coordinate system. For example, a transformation may map an origin defined in a first coordinate system to a point that is not the origin in a second coordinate system. A transformation may be performed using a matrix multiplication. In certain examples, a transformation may be defined as a multi-dimensional array (e.g., matrix) having rotation and translation terms. For example, a transformation may be defined as a 4 by 4 (element) matrix that represents the relative rotation and translation between the origins of two coordinate systems. The terms “map”, “convert” and “transform” are used interchangeably to refer to the use of a transformation to determine, with respect to a second coordinate system, the location and orientation of objects originally defined in a first coordinate system. It may also be noted that an inverse of the transformation matrix may be defined that maps from the second coordinate system to the first coordinate system.

Certain examples described herein refer to “spatial relationships”. These are relationships between points in space. They may comprise a fixed or rigid geometric relationship between one or more points that are tracked by a primary positional tracking system (such as a defined centre-point of a headset) and an auxiliary or secondary tracking system, such as a system for the tracking of auxiliary devices, or it may comprise a spatial relationship between a display on an AR headset (or the plane of that display) and a tracked location on that headset. Spatial relationships may be determined via direct measurement, via defined relative positioning of objects as set by a fixed and specified mounting (e.g., a rigid mount may fix sensor devices or a marker at a specific distance from a headset display or eye location), and/or via automated approaches that compute the relationship based on observed or measured data.

Certain examples described herein are directed towards a “headset”. The term “headset” is used to refer to a device suitable for use with a human head, e.g. mounted upon or in relation to the head. The term has a similar definition to its use in relation to so-called virtual or augmented reality headsets. In certain examples, a headset may also comprise an article of headwear, such as a hard hat, although the headset may be supplied as a kit of separable components. These separable components may be removable and may be selectively fitted together for use, yet removed for repair, replacement and/or non-use. Although the term “augmented reality” (AR) is used herein, it should be noted that this is deemed to be inclusive of so-called “virtual reality” (VR) and “mixed reality” (MR) approaches, e.g. includes all approaches regardless of a level of transparency of an external view of the world. For example, the phrase “pass through” is sometimes used in the context of “virtual reality” to refer to an AR-like display of digital information on an image of the outside world that is acquired by cameras upon the VR headset. The use of the term AR headset covers such VR headsets used in a pass-through mode to provide AR information.

Certain positional tracking systems described herein use one or more sensor devices to track an object. Sensor devices may include, amongst others, monocular cameras, stereo cameras, colour cameras, greyscale cameras, event cameras, depth cameras, active markers, passive markers, photodiodes for detection of electromagnetic radiation, radio frequency identifiers, radio receivers, radio transmitters, and light transmitters including laser transmitters. A positional tracking system may comprise one or more sensor devices upon an object. Certain, but not all, positional tracking system may comprise external sensor devices such as swept-beam tracking beacons or camera devices. For example, an optical positioning system to track an object with active or passive markers within a tracked volume may comprise externally mounted greyscale camera plus one or more active or passive markers on the object.

Certain examples provide a headset for use on a construction site. The term “construction site” is to be interpreted broadly and is intended to refer to any geographic location where objects are built or constructed. A “construction site” is a specific form of an “environment”, a real-world location where objects reside. Environments (including construction sites) may be both external (outside) and internal (inside). Environments (including construction sites) need not be continuous but may also comprise a plurality of discrete sites, where an object may move between sites. Environments include terrestrial and non-terrestrial environments (e.g., on sea, in the air or in space).

The term “render” has a conventional meaning in the image processing and augmented reality arts and is used herein to refer to the preparation of image data to allow for display to a user. In the present examples, image data may be rendered on a head-mounted display for viewing. The term “virtual image” or “augmented reality image” is used in an augmented reality context to refer to an image that may be overlaid over a view of the real-world, e.g. may be displayed on a transparent or semi-transparent display when viewing a real-world object or may comprise an image composed from a captured view of a line of sight and digital information. In certain examples, a virtual image may comprise an image relating to an “information model”. The term “information model” is used to refer to data that is defined with respect to an extrinsic coordinate system, such as information regarding the relative positioning and orientation of points and other geometric structures on one or more objects. For example, the information model may be defined with respect to geodetic or geocentric coordinates on the Earth's surface plus an altitude (e.g., a height above a defined sea level or reference point). In examples described herein the data from the information model is mapped to known points within the real-world as tracked using one or more positional tracking system, such that the data from the information model may be appropriate prepared for display with reference to the tracked real-world. For example, general information relating to the configuration of an object, and/or the relative positioning of one object with relation to other objects, that is defined in a generic 3D coordinate system may be mapped to a view of the real-world and one or more points in that view.

The term “control system” is used herein to refer to either hardware structure that has a specific function (e.g., in the form of mapping input data to output data) or a combination of general hardware and specific software (e.g., specific computer program code that is executed on one or more general purpose processors). An “engine” or a “control system” as described herein may be implemented as a specific packaged chipset, for example, an Application Specific Integrated Circuit (ASIC) or a programmed Field Programmable Gate Array (FPGA), and/or as a software object, class, class instance, script, code portion or the like, as executed in use by a processor.

The term “camera” is used broadly to cover any camera device with one or more channels that is configured to capture one or more images. In this context, a video camera may comprise a camera that outputs a series of images as image data over time, such as a series of frames that constitute a “video” signal. It should be noted that any still camera may also be used to implement a video camera function if it is capable of outputting successive images over time. Reference to a camera may include a reference to any light-based sensing technology including event cameras and LIDAR sensors (i.e., laser-based distance sensors). An event camera is known in the art as an imaging sensor that responds to local changes in brightness, wherein pixels may asynchronously report changes in brightness as they occur, mimicking more human-like vision properties.

The term “image” is used to refer to any array structure comprising data derived from a camera. An image typically comprises a two-dimensional array structure where each element in the array represents an intensity or amplitude in a particular sensor channel. Images may be greyscale or colour. In the latter case, the two-dimensional array may have multiple (e.g., three) colour channels. Greyscale images may be preferred for processing due to their lower dimensionality. For example, the images processed in the later described methods may comprise a luma channel of a YUV video camera.

The term “two-dimensional” or “2D” marker is used herein to describe a marker that may be placed within an environment. Such markers may be used in certain variations described below. The marker may then be observed and captured within an image of the environment. The 2D marker may be considered as a form of fiducial or registration marker. The marker is two-dimensional in that the marker varies in two dimensions and so allows location information to be determined from an image containing an observation of the marker in two dimensions. For example, a 1D marker barcode only enables localisation of the barcode in one dimension, whereas a 2D marker or barcode enables localisation within two dimensions. In one case, the marker is two-dimensional in that corners may be located within the two dimensions of the image. The marker may be primarily designed for camera calibration rather than information carrying, however, in certain cases the marker may be used to encode data. For example, the marker may encode 4-12 bits of information that allows robust detection and localisation within an image. The markers may comprise any known form of 2D marker including AprilTags as developed by the Autonomy, Perception, Robotics, Interfaces, and Learning (APRIL) Robotics Laboratory at the University of Michigan, e.g. as described in the paper “AprilTag 2: Efficient and robust fiducial detection” by John Wang and Edwin Olson (published at the Proceedings of the IEEE/RSJ International Conference on Intelligent Robots and Systems October 2016) or ArUco markers as described by S. Garrido-Jurado et al in the 2014 paper “Automatic generation and detection of highly reliable fiducial markers under occlusion”, (published in Pattern Recognition 47, 6, June 2014), both of which are incorporated by reference herein. Markers may be block or matrix based, or may have other forms with curved or non-linear aspects may also be used (such as RUNE-Tags or reacTIVision tags). Markers also need not be square or rectangular, and may have angled sides. As well as specific markers for use in robotics, common Quick Response—QR—codes may also be used. The 2D markers described in certain examples herein may be printed onto a suitable print medium and/or display on one or more screen technologies (including Liquid Crystal Displays and electrophoretic displays). Although two-tone black and white markers are preferred for robust detection with greyscale images, the markers may be any colour configured for easy detection. In one case, the 2D markers may be cheap disposable stickers for affixing to conventional hard hats to enable relative tracking of auxiliary devices.

The term “control marker”, “set-out marker” or “survey marker” is used to refer to markers or targets that are used in surveying, such as ground-based surveying. Certain examples described herein may use an adaptation of these markers that comprise a reflective and/or clearly patterned surface to allow accurate measurements from an optical instrument such as a total station or theodolite. Similar to the visual markers describe above, these markers or targets may comprise patterned reflective stickers that may be affixed to conventional hard hats to enable relative tracking of auxiliary devices.

### First Example of AR Display on a Construction Site

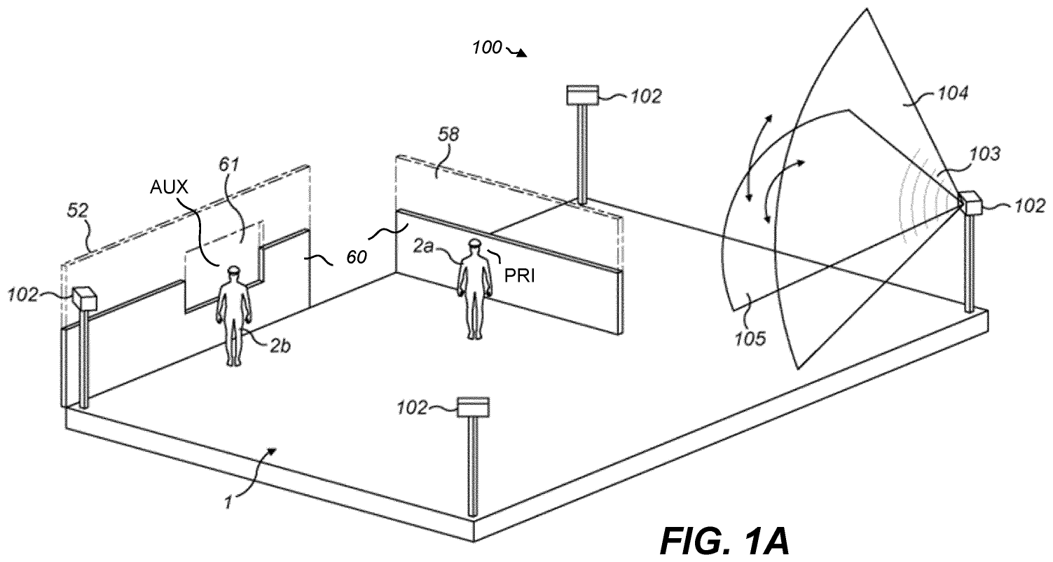

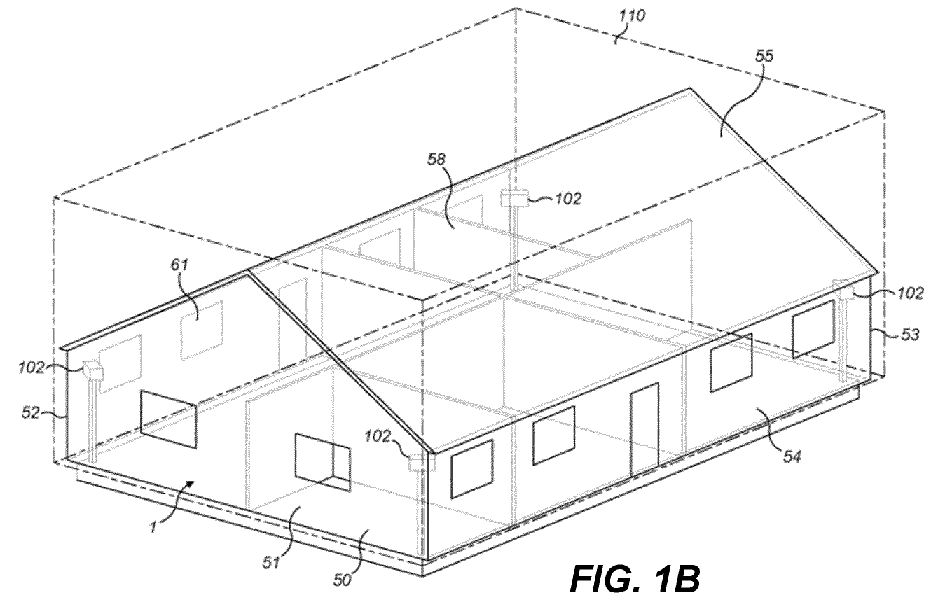

A first example that uses multiple headsets is shown in FIG. 1A. It should be noted that the positional tracking system described in this example is provided for ease of understanding the present invention (e.g., may be seen as a prototype configuration) but is not to be taken as limiting; the present invention may be applied with many different types of positional tracking system being used as a primary positioning system and is not limited to the particular approaches described in the present first example.

FIG. 1A shows a location 1 in a construction site. FIG. 1A shows a positional tracking system 100 that is set up at the location 1. In the present example, the positional tracking system 100 comprises a laser-based positional tracking system as described in WO2019/048866 A1; however, this positional tracking system is used for ease of explanation and the present embodiment is not limited to this type of positional tracking system. In other implementations different positional tracking systems may be used, including optical marker-based high-accuracy positioning systems such as those provided by NaturalPoint, Inc of Corvallis, Oregon, USA (e.g., their supplied OptiTrack systems), and monocular, depth and/or stereo camera simultaneous localisation and mapping (SLAM) systems. SLAM systems may be sparse or dense, and may be feature-based and/or use trained deep neural networks. So-called direct systems may be used to track pixel intensities and so-called indirect systems may be feature-based. Indirect methods may be trained using deep neural networks. Examples of “traditional” or non-neural SLAM methods include ORB-SLAM and LSD-SLAM, as respectively described in the papers “ORB-SLAM: a Versatile and Accurate Monocular SLAM System” by Mur-Artal et al. published in IEEE Transactions on Robotics in 2015 and “LSD-SLAM: Large-Scale Direct Monocular SLAM” by Engel et al as published in relation to the European Conference on Computer Vision (ECCV), 2014, both of these publications being incorporated by reference herein. Example SLAM systems that incorporate neural network architectures include “CodeSLAM—Learning a Compact Optimisable Representation for Dense Visual SLAM” by Bloesch et al (published in relation to the Conference on Computer Vision and Pattern Recognition—CVPR—2018) and “CNN-SLAM: Real-time dense Monocular SLAM with Learned Depth Prediction” by Tateno et al (published in relation to CVPR 2017), these papers also being incorporated by reference herein. It will be understood that the base stations 102 may be omitted for certain forms of SLAM positional tracking system.

In FIG. 1A, the example positional tracking system 100 comprises a plurality of spaced apart base stations 102. In one particular implementation example, a base station 102 comprises a tracking device that is selectively operable to emit an omnidirectional synchronisation pulse 103 of infrared light and comprises one or more rotors that are arranged to sweep one or more linear non-visible optical fan-shaped beams 104, 105 across the location 1, e.g. on mutually orthogonal axes as shown. In the present embodiment, the base stations 102 are separated from each other by a distance of up to about 5-10 m. In the example of FIG. 1A, four base stations 102 are employed, but in other embodiments fewer than four base stations 102 may be used, e.g. one, two or three base stations 102, or more than four base stations. As described in WO2019/048866 A1, by sweeping the laser beams 104, 105 across the construction site 1 at an accurate constant angular speed and synchronising the laser beams 104, 105 to an accurately timed synchronisation pulse 103, each base station 102 in the laser positional tracking system may generate two mutually orthogonal spatially-modulated optical beams 104, 105 in a time-varying manner that can be detected by opto-electronic sensors within the tracked volume for locating the position and/or orientation of one or more tracked objects within the tracked volume. Other positional tracking systems may use other technologies to track an object using different technologies, including the detection of one or more active or passive markers located on the object as observed by tracking devices in the form of one or more cameras mounted at the base stations 102 and observing the tracked volume. In SLAM systems tracking may be performed based on a stream of data from one or more camera devices (and possible additional odometry or inertial measurement unit-IMU-data).

FIG. 1A also shows two users 2a, 2b. A first user 2a wears a primary positioning device (denoted “PRI” in the Figure), in this case in the form of a hard hat with an accompanying AR headset, wherein the device has sensors that are arranged to detect signals emitted from one or more of the base stations 102. The primary positioning device is configured to be located within the location 1. A second user 2b wears an auxiliary AR headset (denoted “AUX” in the Figure). The auxiliary AR headset does not comprise sensors for the positional tracking system 100. Instead, the auxiliary AR headset is tracked relative the primary positioning device. For example, the primary positioning device may comprise one or more camera devices and/or one or more laser scanning devices, e.g. in addition to the sensors for the positional tracking system 100. These devices may enable the position and orientation of the auxiliary AR headset to be determined from the primary positioning device. Although only one auxiliary AR headset is shown in the Figure, in practice there may be many such headsets surrounding the primary positioning device and the first user 2a, e.g. there may be a group inspecting the construction site that is accompanying a site foreperson or lead member that is wearing the primary positioning device. Via local or remote processing, the relative position and orientation of the auxiliary AR headset and the position and orientation of the primary positioning device (as determined with the positional tracking system 100) are used to determine a position and orientation of the auxiliary AR headset with respect to the construction site. For example, a calibrating transformation may map between a coordinate system of the positional tracking system 100 and an extrinsic (e.g., geographic) coordinate system. This may allow for a virtual image to be generated based on the pose of the first user 2a (e.g., aligning BIM information with a current gaze of the first user 2a) and displayed in the AR headset of the first user 2a. Similarly, a pose of the second user 2b may be determined, e.g. with respect to one or more of the coordinate system of the positional tracking system 100 and the extrinsic (e.g., geographic) coordinate system, that enables a virtual image to be generated based on the pose of the second user 2b (e.g., aligning BIM information with a current gaze of the second user 2b) and displayed in the auxiliary AR headset of the second user 2b. In a case where the pose of the auxiliary AR headset is determined at the primary positioning device, this pose may be wirelessly communicated to the auxiliary AR headset for display of AR information via the auxiliary AR headset. AR information, such as at least portions of a BIM, may thus be displayed to both users 2a, 2b, e.g. via a head-mounted display (HMD) of the headset. For example, in FIG. 1A, a virtual image of one or more internal partitions 52, 58 that are defined in the BIM may be shown that are aligned with part-constructed portions of a building 60.

As an example, FIG. 1B shows a three-dimensional BIM 110 for a building 50 to be constructed. The building 50 has exterior walls 51, 52, 53, 54, a roof 55 and interior partitions, one of which is shown at 58. One of the walls 52 is designed to include a window 61. The BIM 110 is defined with respect to an extrinsic coordinate system, which may be a geographic coordinate system (e.g., a set of terrestrial coordinates) or a specific Computer Aided Design (CAD) reference origin. By configuring the alignment of the BIM 110 with the first location 1, a user 2a, 2b may see how a portion of the building in progress, such as window 61 matches up with the original three-dimensional specification of the building within the BIM. Adjustments may then be made to the building in progress if the building 50 is not being constructed according to the specification. The BIM may comprise multiple layers that show different parts of a building, such as services (electricity, gas, and/or communications conduits), interior constructed portions, and/or interior fittings.

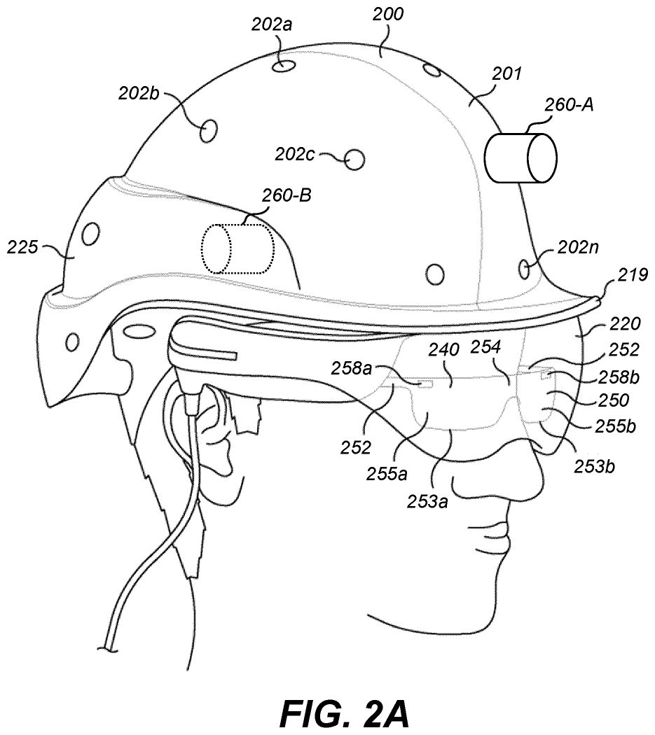

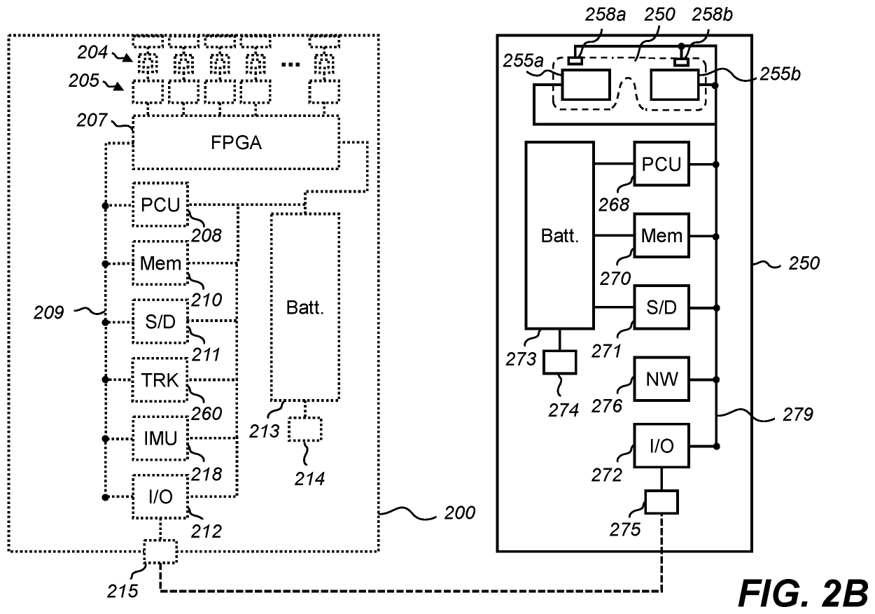

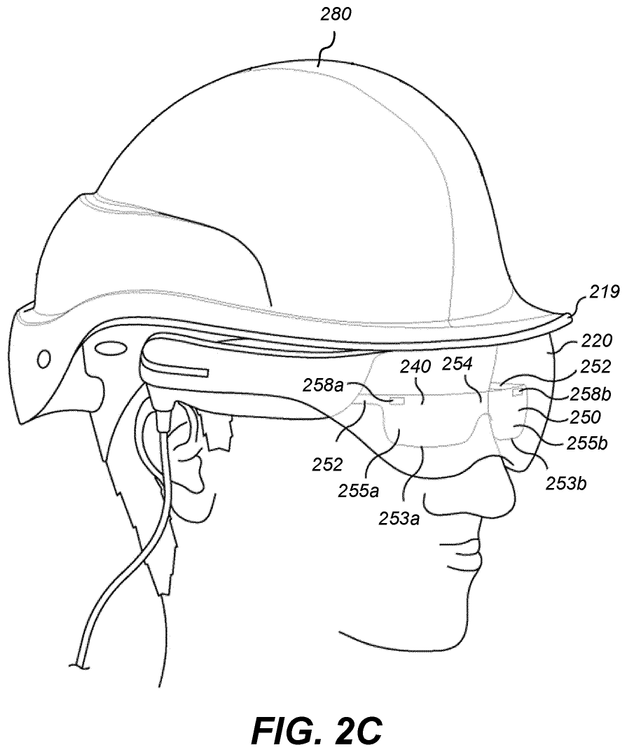

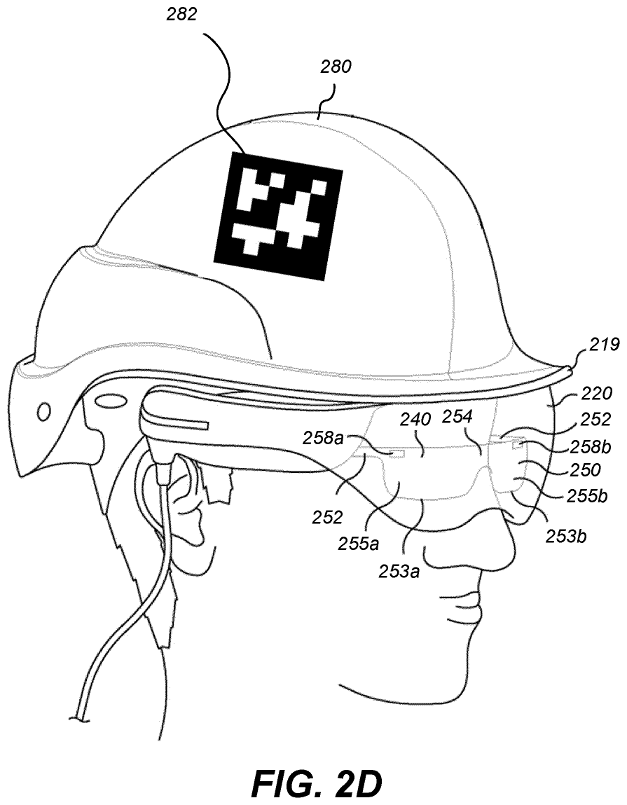

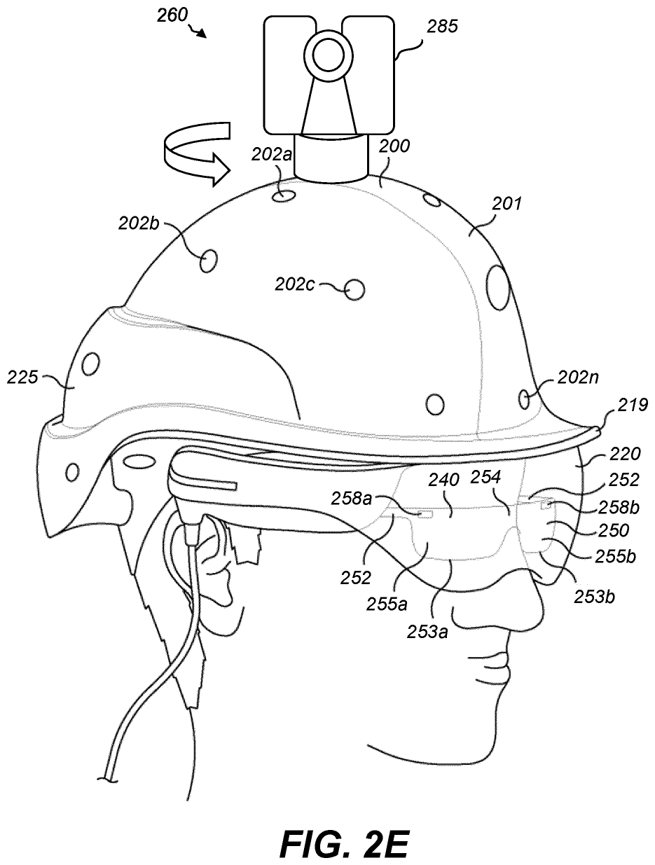

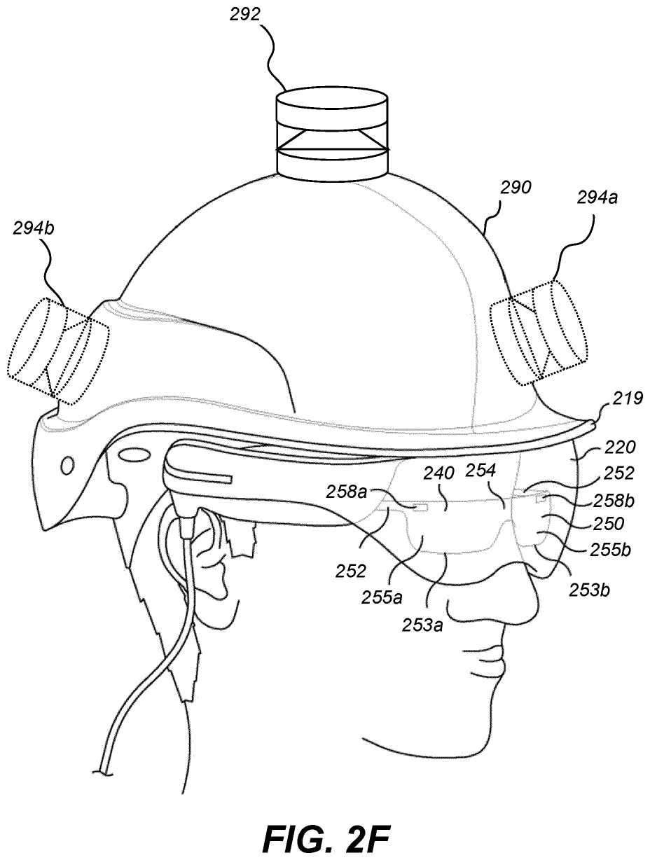

FIG. 2A shows a hard hat 200 and a set of augmented reality glasses 250 that may be used to provide a primary positioning device in certain examples. For example, the configuration in FIG. 2A may form a primary AR headset for displaying an augmented reality BIM within a construction site. The primary positioning device may comprise an adapted version of a headset similar to that described in WO2019/048866 A1, with certain important differences as described below. It should be noted that FIGS. 2A and 2B shows just one possible hardware configuration; the method described later below may be performed on different hardware for different implementations.

In FIG. 2A, the hard hat 200 comprises an article of headwear in the form of a construction helmet 201 of essentially conventional construction, which is fitted with a plurality of sensor devices 202a, 202b, 202C, . . . , 202n and associated electronic circuitry, as described in more detail below, for tracking the position of the hard hat 200 using a positional tracking system, such as the positional tracking system 100. It should be noted that in other examples other positional tracking systems may be used such as an optical tracking system and the sensors replaced with equivalents in those systems, such as active and/or passive optical markers. The helmet 201 comprises a protruding brim 219 and may be configured with the conventional extras and equipment of a normal helmet. In the present example, the plurality of sensor devices 202 track the position of the hard hat 200 within a tracked volume defined by a positional tracking system that is set up at a construction site, such as the positional tracking system 100 at the location 1 as described above in relation to FIG. 1A. Although FIGS. 2A and 2B comprise particular sensor devices for particular positioning systems, these are provided for ease of explanation only; implementations may use any type or technology for the positioning systems, including known or future “off-the-shelf” positioning systems.

FIG. 2B shows different portions of electronic circuitry that may form part of a primary AR headset, such as the arrangement of FIG. 2A. In this case, components of the electrical circuitry mounted within, upon, or in association with the hard hat 200 are shown with a dashed outline. This is because these components may be omitted when providing an auxiliary AR headset. For example, an auxiliary AR headset may comprise a set of augmented reality glasses 250 without sensor devices for a positional tracking system. This may enable auxiliary AR headsets to have a lower cost, be lighter, have better battery life, and/or be supplied as part of a mass-produced AR headset that is not coupled to a hard hat. The primary AR headset may have a set of augmented reality glasses 250 that are the same or different from the augmented reality glasses of the auxiliary AR headsets. In one case, the components that form part of augmented reality glasses 250 are shared by both the primary and auxiliary AR headsets. In one case, the sensor devices that form part of the hard hat 200 may form part of a modular kit, wherein a hard hat as shown in FIG. 2A that is equipped with sensor devices for the positional tracking system may be removably coupled with augmented reality glasses 250. In this case, an auxiliary AR headset may be created by removing the hard hat equipped with sensor devices (e.g., unplugging any communicative couplings and mountings) and replacing said hard hat with a conventional (e.g., unadapted) hard hat as used on the construction site. In other cases, the auxiliary AR headset may form a separate device to the primary AR headset, e.g. they may be provided as separate stand-alone devices.

The example primary positioning device in FIG. 2A shows a set of n sensor devices 202i that are mounted with respect to the helmet 201. The number of sensor devices may vary with the chosen positional tracking system 100, but in the example shown in FIG. 1A, n may equal 32. In these examples, the sensor devices 202i are distributed over the outer surface of the helmet 201, and in certain examples at least five sensors may be required to track the position and orientation of the hard hat 200 with high accuracy.

When supplying the primary AR headset, as shown in FIG. 2B, each sensor device 202i may comprise a corresponding photodiode 204 that is sensitive to infrared light and an associated analogue-to-digital converter 205a. The photodiodes 204 may be positioned within recesses formed in the outer surface of the helmet 201. Digital pulses received from the analogue-to-digital converters 205 may be time-stamped and aggregated by a Field Programmable Gate Array (FPGA) 207. In the primary AR headset, the FPGA 207 may be connected to a processor 208 by a local data bus 209. The local data bus 209 also connects to a memory device 210, a storage device 211, and an input/output (I/O) device 212. The electronic components for the position tracking of the primary AR headset may be powered by a rechargeable battery unit 213. A power connector socket 214 is provided for connecting the battery unit 213 to a power supply for recharging. The I/O device 212 may comprise a dock connector 215 such, for example, a USB port, for communicatively coupling the electronic circuitry of the hard hat 200 to other devices and components. The local data bus 209 also connects to an (optional) inertial measurement unit (IMU) 218 of the kind found in virtual reality and augmented reality headsets, which comprises a combination of one or more accelerometers and one or more gyroscopes. The IMU may comprise one accelerometer and one gyroscope for each of pitch, roll and yaw modes. For different positioning system technologies, components 204, 205 and 207 may be replaced with corresponding sensor devices for those technologies (e.g., camera-based devices for SLAM methods). The electronic components of the primary AR headset may be accommodated within a protected cavity 225 formed in the helmet 201 as shown in FIG. 2A. The hard hat 200 may have suspension bands inside the helmet 201 to spread the weight of the hard hat 200 as well as the force of any impact over the top of the head.

FIG. 2C shows an example of a hard hat configuration for an auxiliary AR headset. As may be seen, certain components may be shared with the primary AR headset. However, the hard hat component 280 in FIG. 2C is different to the helmet 201 shown in FIG. 2A. Other examples of an auxiliary AR headset are shown in FIGS. 2D and 2F and will be explained separately later below.

In the present examples, both the primary and auxiliary AR headsets may comprise a set of safety goggles 220, which may protect the user's eyes while on location in the building site, and the augmented reality glasses 250, which are mounted inside the goggles 220. The goggles 220 may be mounted to a corresponding hard hat such that they are recessed slightly behind the brim 219 to afford a degree of protection for the goggles 220. It will be understood that in embodiments where the augmented reality glasses 250 themselves are ruggedised and ready for construction, the safety goggles 220 may be omitted. In other embodiments, the hard hat may comprise a safety visor.

In the examples of FIGS. 2A, and 2C to 2F, the augmented reality glasses 250 comprise a shaped transparent (i.e., optically clear) plate 240 that is mounted between two temple arms 252. In these examples, the augmented reality glasses 250 are attached to a corresponding hard hat such that they are fixedly secured in an “in-use” position behind the safety goggles 220. For, the primary AR headset this “in-use” position may be fixed with reference to relative to the sensors 202i; for auxiliary AR headsets, this “in-use” position may be fixed with reference to the hard hat or one or more detectable portions, sensors, or devices upon the hard hat. The augmented reality glasses 250 may, in some embodiments, be detachable from a corresponding hard hat, or they may be selectively movable, for example by means of a hinge between the hard hat and the temple arms 252, e.g. from an in-use position to a “not-in-use” position (not shown) in which they are removed from in front of the user's eyes.

In the examples of FIGS. 2A, and 2C to 2F, the transparent plate 240 is arranged to be positioned in front of the user's eyes and comprises two eye regions 253a, 253b, which are arranged to be disposed in front of the user's right and left eyes respectively, and an interconnecting bridge region 254. Attached to, or incorporated in, each of the eye regions 253a, 253b is a respective transparent or semi-transparent display device 255a, 255b for displaying augmented reality media content to a user as described below, whilst allowing the user to view his or her real-world surroundings through the glasses 250. The augmented reality glasses 250 also comprise lenses (not shown) positioned behind each display device 255a, 255b for viewing an image displayed by each display device. In some examples, the lenses may be collimating lenses such that an image displayed by each display device 255a, 255b appears to the user to be located at infinity. In some examples, the lenses may be configured to cause rays of light emitted by the display devices 255a, 255b to diverge, such that an image displayed by each display device 255a, 255b appears at a focal distance in front of the augmented reality glasses 250 that is closer than infinity. In the present example, the lenses are configured and arranged with the display devices 255a, 255b such that images displayed by the display devices 255a, 255b appear to be located at a focal distance of 8 m in front of the user. It should be noted that the configuration of the augmented reality glasses 250 may also change as technologies develop-they may be implemented by any set of hardware suitable for displaying an overlay of a virtual image for augmented reality. In other examples, similar systems may also be used for virtual reality applications.

In certain variations, eye-tracking devices may also be used. These may not be used in all implementations but may improve display in certain cases with a trade-off of additional complexity. The later described methods may be implemented without eye-tracking devices.

The example of FIGS. 2A and 2B shows additional optional eye-tracking hardware that may be used in variations. Within each eye region 253a, 253b, the transparent plate 240 carries a respective eye-tracking device 258a, 258b for tracking the position of the user's eyes when the corresponding headset is worn. In particular, each of the eye-tracking devices 258a, 258b is configured to detect the position of the centre of the pupil of a respective one of the user's eyes for the purpose of detecting movement of the augmented reality glasses 250 relative to the user's eyes in use and to generate and output display position data relating the position of the augmented reality glasses 250 relative to the user's head. Those skilled in the art will be aware of numerous other solutions for tracking the position of the augmented reality glasses 250 relative to the user's head in use, including optical sensors of the kind disclosed by U.S. Pat. No. 9,754,415 B2 and a position obtaining unit of the kind disclosed by US 2013/0235169 A1, both of which are incorporated by reference herein. Monitoring movement of the augmented reality glasses 250 relative to the user's head may be useful in cases where the hard hat is liable to move relative to the user's head but may not be required where the hard hat is relatively secured to the user's head or where the position and orientation of the augmented reality glasses 250 are tracked (e.g., relatively from the primary positioning device). In the present described variation, two eye-tracking devices 258a, 258b are provided, one associated with each of the user's eyes, but in other implementations, a single eye-tracking device may be employed associated with one of the eyes.

In terms of the electronic circuitry as shown in FIG. 2B, the transparent display devices 255a, 255b and optional eye-tracking devices 258a, 258b are connected to a local data bus 279 for interconnection with a processor 268, a memory unit 270, a storage device 271, and an input/output (I/O) device 272. Power for the electronic components is provided by a rechargeable battery unit 273, which is connected to a power connector socket 274 for connecting the battery unit 273 to a power supply for recharging. The local data bus 279 is also connected to a dock connector 275 and a network interface 276. The network interface 276 may comprise a wireless (WiFi) microcontroller. Although the example of FIG. 2B shows separate battery supplies, in other examples, a single power connector socket may be provided for both the hard hat 200 and the glasses 250, and in some examples, a single rechargeable battery unit may be provided for powering both sets of electronic circuitry. Again, if the eye-tracking hardware is not provided, the augmented reality glasses 250 may have a similar construction without eye-tracking devices 258a, 258b.

The present example of FIGS. 2A and 2B differs from the corresponding examples of WO2019/048866 A1 in that the headset also comprises a secondary tracking system 260 for tracking one or more auxiliary AR headsets relative to the primary AR headset as shown in FIG. 2A. In the example of FIG. 2A, the secondary tracking system 260 comprises a camera-based system whereas in the example of FIG. 2E, the secondary tracking system 260 comprises a laser-based system. Various tracking systems may be used to implement the secondary tracking system 260 including combinations of the examples of FIGS. 2A and 2E. The secondary tracking system 260 may comprise one or more sensor devices that are mounted on the hard hat 200 as well as corresponding electronic circuitry as shown by the reference “TRK” in FIG. 2B. It should be noted that in certain examples, a (primary) positional tracking system and the secondary tracking system 260 may comprise a shared or common set of sensor devices, such as a set of camera devices. In this case, the sensor devices 202 may be omitted from the helmet 201 in FIG. 2A. The secondary tracking system 260 is configured to track auxiliary AR headsets relative to the primary AR headset. FIGS. 2C to 2F show various examples of how this may be achieved.

In the example of FIG. 2C, the secondary tracking system 260 comprises one or more camera devices on the hard hat 200 of the primary AR headset that are arranged to visually track the hard hats of the auxiliary AR headsets. For example, the one or more camera devices may comprise one or more camera devices with a wide-angle field of view (e.g., within a horizontal extent) so as to capture images of the area surrounding the primary AR headset. Here, the term “wide” may refer to a field of view that is greater than 90 degrees in the horizontal direction. Considering a distribution of human heights, and surface heights within a construction site, a vertical field of view may be constrained yet retaining the ability to track the hard hats of the auxiliary AR headsets. The quality of the camera devices may be selected based on a tracking accuracy. For example, relatively low-resolution camera devices may be able to capture images that enable the relative position and orientation of the hard hat 280 to be determined. In certain cases, multiple camera devices may be provided upon the hard hat 200 of the primary AR headset so as to capture a wide angle around the primary AR headset. For examples, two camera devices 260-A and 260-B are shown in FIG. 2A. In certain cases, four camera devices may be mounted (e.g., with 90-degree fields of view) to enable a full or approximately full view of the surroundings of the primary AR headset. In other cases, different numbers of camera devices with different or common fields of view may be combined to provide a 360-degree field of view, including use of a single 360-degree field of view camera (e.g., as positioned at the top of the hard hat 200 or mounted within an upper circumference of the hard hat 200).

In the example of FIG. 2C, images from one or more camera devices may be supplied to one or more computer programs for detection of auxiliary AR headsets and determination of one or more of position and orientation of the same. For example, firmware or other computer program code may be loaded into memory 210 and executed by the processor 208 to determine poses of hard hats corresponding to auxiliary AR headsets that are located in an area surrounding the primary AR headset and that feature within images captured by the one or more camera devices. In certain cases, the one or more camera devices may comprise video devices or the like that are arranged to provide a stream of images (e.g., video frames). Detection of auxiliary AR headsets and determination of one or more of position and orientation of the same may be performed on one or more frames supplied from this stream. Processing may be performed on every frame or every n-frames (e.g., depending on computing resources). In one case, a conditional processing pipeline may comprise detection and pose determination stages, which may be sequential. The detection stage may comprise a function optimised for speed that may run on every frame, or on every m frames, where m is selected to provide the processing of a relatively high number of frames per second (e.g., 5-20). Responsive to a hard hat being detected within a frame, said frame may then be passed to the pose determination for determination of the position and orientation of the hard hat within the frame. Hence, the detection stage may act as a filter such that the pose determination is performed conditional on auxiliary AR headsets being detected in the vicinity.

The pose determination stage may use one or more frames to determine the position and orientation of the hard hat 280 associated with an auxiliary AR headset. For example, the pose determination stage may comprise a computer vision function provided by an image processing library that is configured to determine a pose of a located object. The pose determination stage may receive positioning data indicating the position of the located object (i.e., the hard hat 280) within the image (e.g., in the form of a bounding box or centroid). The pose determination stage may be programmed based on known dimensions of a standardised hard hat and/or may determine a size of the hard hat from one or more images. The pose determination stage may determine a pose relative to one or the one or more camera devices on the hard hat 200 of the primary AR headset. For example, the pose determination stage may solve a perspective-n-point (PNP) problem, given the locations of n 3D points on the hard hat 280 and corresponding points with a captured image. In certain cases, the pose determination stage may determine a pose of the second user 2b wearing the auxiliary AR headset as opposed to the hard hat 280 (e.g., based on locations of key facial features such as the corners of the mouth, nose, and/or eyes or lower parts of the AR glasses 250), or the pose of the AR glasses 250 themselves (e.g., using predefined salient points on the AR glasses). In certain examples, one or more of the AR glasses 250 or the hard hat 280 may be equipped with electromagnetic (such as infra-red) point beacons at predefined locations. In other cases, one or more of the AR glasses 250 or the hard hat 280 may have distinctive markings at a plurality of known locations (e.g., a series of dots or geometric shapes) that may be detected within captured images (e.g., based on thresholding or a trained deep neural network). The pose determination stage may be supplied (e.g., in the form of data loaded into memory 210) with the intrinsic parameters of the one or more camera devices (e.g., focal length, optical centre, and radial distortion parameters). Alternatively, these may be approximated during image acquisition. Any used intrinsic parameters of the one or more camera devices may be measured and stored as part of a setup or calibration phase prior to use or loaded based on a factory calibration. The pose determination stage may use one or more of the solvePnP or the solvePnPRansac functions provided by the OpenCV library.

Alternatively, the pose determination stage may utilise a trained deep neural network. In one case, both detection and pose determination stages may be combined as one inference process for a deep neural network that receives a frame of image data (e.g., greyscale, YUV or RGB) and outputs one or more 6 degrees-of-freedom poses (i.e., a 6-parameter variable) for detected auxiliary AR headsets. Such a deep neural network may be based on a convolutional neural network followed by a feed-forward neural network. Training data may be obtained in a controlled setting by placing the primary AR headset and an auxiliary AR headset in known or measured relative poses and then acquiring image data from the one or more camera devices. The pairs of acquired images and 6D poses may then be used as training samples (e.g., in the form of (X, Y) tuples). In one case, training data may be obtained by using equipment that is tracked by the positional tracking system 100, e.g. using a primary AR headset as the auxiliary AR headset, such that the pose of the headset tracked by the secondary tracking system 260 is provided by the (high-accuracy) positional tracking system. Recording poses and images over an extended time period may provide enough training data to train a deep neural network architecture. In another case, a trained face or head pose estimation system may be used to determine the pose of the auxiliary AR headset.

If the pose of the auxiliary AR headset is determined relative to one or more camera devices then this may be transformed into one or more of a pose relative to an extrinsic coordinate system (i.e., a coordinate system in which the AR information is defined) or a pose with respect to the positional tracking system so as to provide a pose of the auxiliary AR headset that is defined with respect to AR information such as a BIM to allow the AR information to be combined with a view seen by the auxiliary AR headset. This may use a known fixed spatial relationship between the location of an identified camera device (e.g., a camera device that has provided an image that was used for pose estimation for the auxiliary AR headset) and an origin or tracked centroid with respect to the coordinate system used by the positional tracking system. The AR information may be mapped from the extrinsic coordinate system in which it is defined into the coordinate system used by the positional tracking system or the position of the primary AR headset may be mapped into the extrinsic coordinate system. In the case, where the pose of an auxiliary AR headset is determined with respect to the identified camera device, using the spatial relationship this pose may then be defined with reference to one of the extrinsic coordinate system or the coordinate system of the positional tracking system to allow the combination of AR information and a view from a headset via the AR glasses 250. Additional details of mappings between coordinate systems for a camera and a positional tracking system are described in PCT/EP2022/052532, which is incorporated herein by reference. If the pose of the auxiliary AR headset is defined with reference to a known centroid of one or more of a face, hard hat 280, or AR glasses 250 then it may be transformed to be defined with respect to a known centroid (e.g., again based on known spatial relationships defined with respect to the auxiliary AR headset) to allow combination of AR information with a field of view of the AR glasses 250.

In examples, alignment of a coordinate system used to define AR information, such as a BIM, with a coordinate system used by the positional tracking system of the primary positioning device may be provided via a calibration procedure. This calibration procedure may involve locating a set of points within the coordinate system used by the positional tracking system that also have known positions within the coordinate system used to define AR information (e.g., an extrinsic/geographic coordinate system). By comparing a plurality of points defined in both coordinate systems an appropriate transformation between the coordinate systems may be derived.

### Variation of Auxiliary AR Headset

FIG. 2D shows a variation of the example of FIG. 2C, which may be used to simplify the determination of the pose of the auxiliary AR headset. In this case, the hard hat 280 is provided with a known marker pattern 282. For example, the known marker pattern 282 may comprise a checkerboard pattern, one or more visual markers such as the APRIL tags or ArUco markers, or another distinctive visual texture. If visual markers are provided, these may be located in multiple locations on the hard hat 280 (e.g., on the front, back, and sides) to enable detect from multiple observation angles. Similarly, textured or checkerboard patterns may be located over a whole or substantial part of the hard hat 280. In these cases, the known marker pattern 282 may be detected and a pose determined based on known geometric properties of the marker pattern 282 (e.g., known spacings between corners). For example, corner positions within the known marker pattern 282 may provide points for a PNP solver function.

In more detail, when using the auxiliary AR headset as shown in FIG. 2D, one or more camera devices that form part of the primary AR headset as shown in FIG. 2A acquire images of the surrounding physical space. A marker detection function may be applied to each acquired image to detect the presence of the known marker pattern 282. The known marker pattern 282 may be detected using feature-based image recognition functions. In one example, an image may be subject to Harris corner detection or the like to determine if a set of corners exist with a normalised spacing between corners. In another example, a deep neural network architecture may be trained to recognise the known marker pattern 282. Training data for the deep neural network architecture may be generated by recording camera footage from the primary AR headset while one or more auxiliary AR headsets with the known marker pattern 282 move around the primary AR headset (e.g., similar to that described for the case of FIG. 2C above). The camera footage may then be manually labelled with bounding boxes locating the known marker pattern 282 or this may be performed using calibrated library functions that are configured to detect the known marker pattern 282 (e.g., as instructed within computer vision programming libraries). As per the example of FIG. 2C, an image in which the known marker pattern 282 is detected may then be supplied to a camera pose determination function (e.g., together with an identifier of the camera that supplied the image). The camera pose determination function estimates a pose of the camera with respect to the 2D marker 540, i.e. determines a position and orientation of the camera with respect to the known marker pattern 282. The camera pose determination function may use a pose determination function from a known computer vision software library, such as the detectMarkers or estimatePoseSingleMarker function provided as part of a library of functions for use with ArUco markers, or the solvePnP function provided by the OpenCV library of functions. Custom pose determination functions may also be programmed and/or embodied in hardware such as Field Programmable Gate Arrays, e.g. based on known approaches. In certain cases, known matrix inverse functions may be used to determine the pose of the camera, in particular the pose of the camera origin, with respect to the known marker pattern 282 if available functions determine the pose of the known marker pattern 282 with respect to the camera. Many camera pose determination functions first determine corner locations of the known marker pattern 282. For example, this may involve application of a corner detection function using a known corner detection algorithm, such as the Harris corner detection algorithm. One or more of a pattern detection function and a camera pose determination function may obtain data indicating defined properties of the known marker pattern 282, such as known spatial dimensions (i.e., positions of the corners with respect to each other in millimetres). In certain cases, the camera-pose determination function also uses predefined camera properties, such as focal length and/or distortions (which may be provided as an intrinsic camera matrix). These may be stored as configuration data accessible within the primary AR headset.

Regardless of whether the example of FIG. 2C or FIG. 2D is used, a relative pose of an auxiliary AR headset from a primary AR headset is determined. This relative pose may then be mapped to an absolute pose of the auxiliary AR headset within a coordinate system representing the construction site such that AR information regarding the construction site may be displayed to a user of the auxiliary AR headset.

### Further Example of Primary and Auxiliary AR Headsets

FIGS. 2E and 2F show a different example of a set of primary and auxiliary AR headsets. Unless stated otherwise aspects of the examples of FIGS. 2A to 2D as described above may also apply to the example of FIGS. 2E and 2F, and components with like reference numerals may be assumed to be as described with respect to the example of FIGS. 2E and 2F. Furthermore, the example of FIGS. 2E and 2F is compatible with the example and variation of FIGS. 2A to 2D and the two approaches may be combined with a final process of pose fusion for the auxiliary AR headset. Additionally, although the example of FIGS. 2E and 2F uses the same positional tracking system as the examples of FIGS. 2A to 2D, as for the latter examples, different positional tracking systems may be used, such as those that use optical markers, SLAM, and/or other high-accuracy approaches. It should further be noted that the example of FIGS. 2E and 2F shows a prototype system and production models may vary in design and appearance.

The example of FIGS. 2E and 2F uses a secondary tracking system 260 in the form of a laser scanner 285 that is mounted on the hard hat 200 of the primary AR headset. The laser scanner 285 may comprise a 360-degree 3D laser scanner that is configured to emit beams of electromagnetic radiation (e.g., in the form of modulated infra-red laser beams). The laser scanner 285 may comprise a receiving apparatus to receive reflected electromagnetic radiation and use the received electromagnetic radiation to determine a point location of the reflecting object. In one case, the laser scanner 285 may comprise a rotatable laser emitter that is able to rotate 360-degrees to scan an area surrounding the primary AR headset. In another case, the laser scanner 285 may comprise an electro-mechanical system that sweeps one or more laser beams to scan said area. In yet another case, the laser scanner 285 may comprise multiple laser emitters configured to sweep a portion of a 360-degree view. In one case, the laser scanner 285 may comprise a modified or miniaturised form of a commercial laser scanner, such as those provided by Stonex SRL of Monza, Italy or Leica Geosystems AG of Gallen, Switzerland (now owned by Hexagon AB of Stockholm, Sweden).

FIG. 2F shows an auxiliary AR headset where a hard hat 290 is provided with one or more retroreflectors 292, 294 that are arranged to reflect electromagnetic radiation emitted by the laser scanner 285. For example, the retroreflectors 292, 294 may comprise an adapted form of retroreflectors 292, 294 using in conventional surveying markers or surveying poles. The retroreflectors 292, 294 are configured to reflect electromagnetic radiation emitted by the laser scanner 285 back to the laser scanner for detection. For example, the laser scanner 285 may comprise sensor devices, photodetectors, and analogue-to-digital convertors similar to the configuration for detection of electromagnetic radiation described with reference to components 202, 204 and 205 of the positional tracking system of the example of FIG. 2A. In one case, the laser scanner 285 operates in a similar manner to a motorised or robotic total station or total station theodolite, using electronic distance measurement to measure a distance to a retroreflector. For example, an emitted laser beam may comprise a modulated infrared carrier signal, where the modulation of the transmitted and received laser beams are compared (e.g., in terms of frequency) to determine a distance to the retroreflector (e.g., initially in the form of a phase difference or number of wavelengths). The laser scanner 285 may determine an angle measurement of a reflected beam using electro-optical scanning. In cases, where the laser scanner 285 determines a location of the retroreflector using polar coordinates, this may be converted into cartesian coordinates using known methods. In general, the laser scanner 285 is at least able to determine a position of a retroreflector using a combination of angle measurement when a reflected beam is detected and a distance to the reflecting object (the retroreflector) using electronic distance measurement. In certain cases, a height may be determined with a vertically scanning beam (e.g., within a narrow range of angles representing possible relative height locations) and/or configured based on an entered height of the users wearing the primary and secondary AR headsets. In certain cases, a height may not be needed as the 3D geometry of the hard hat 290 and the known positions of the retroreflectors may enable pose estimation with measurements within a 2D horizontal plane. In certain cases, the laser scanner 285 may be configured to perform 360-degree scans at a plurality of vertical levels to capture multiple 2D planes of located points.

FIG. 2F shows one case where multiple retroreflectors are used. A primary retroreflector 292 is mounted at the top of the hard hat 290 and two retroreflectors 294a and 294b are shown mounted at respective front and rear positions. A plurality of retroreflectors may be mounted around the circumference of the hard hat 290 with a frequency to allow accurate detection of at least three retroreflectors from multiple viewing angles.

In general, the example of FIGS. 2E and 2F allows the position of one or more points on the hard hat 290 associated with the auxiliary AR headset to be determined. In a similar manner to the example of FIGS. 2C and 2D, given the determined location of said points, and the known 3D geometry of the retroreflectors upon the hard hat 290, a pose of the hard hat 290 may be determined relative to the primary AR headset (e.g., relative to the laser scanner 285). For example, once the positions of three or more points are determined using the laser scanner 285, these may be provided to solve the PNP problem as described for the example of FIGS. 2C and 2D, e.g. together with the geometry of the retroreflector mountings and any distortion or calibration parameters of the laser scanner 285. Hence, the examples of FIGS. 2C, 2D, and 2F may operate in a similar manner to determine the pose with different methods to determine the location of points upon a hard hat associated with an auxiliary AR headset.

In one variation, the laser scanner 285 may comprise a beacon similar to one of the base stations 102 shown in FIG. 1A. In this case, the auxiliary AR headset may be equipped with a sensor system similar to that shown in FIG. 2A and used for the positional tracking system 100. However, in the present case, sensors such as 202, 204, 205 etc. that are provided as part of the auxiliary AR headset may be a separate and independent closed system to the positional tracking system used to locate the primary AR headset. For example, the laser scanner 285 and sensor set for the auxiliary AR headset in this case may comprise a scaled-down version of the tracking system shown in FIG. 1A., with a reduced number of base stations and hard hat sensors. In one case, such a scaled down version may be configured to have a lower accuracy that the positional tracking system used to locate the primary AR headset.

In another variation the laser scanner 285 may comprise a wide-angle or 360-degree LIDAR scanner. In this case, the laser scanner 285 may generate a 3D point cloud of an area or volume surrounding the primary AR headset. In this case, the pose of the auxiliary AR headset relative to the laser scanner 285 may be determined by processing the point cloud, e.g. to detect shapes resembling one or more of the users head and a hard hat similar to hard hat 280 in FIG. 2C.

In certain cases, the hard hat associated with the auxiliary AR headset may comprise modulation devices to modulate laser light reflected by the hard hat and thus identify points within the 3D point cloud as belonging to the hard hat. In certain cases, the geometry of the hard hat may be used to determine a set of points surrounded by free space that represent the hard hat. Those points may then be processed to determine the pose (e.g., based on an orientation of a known shape fitted to the points within the 3D space of the point cloud).

### Communication Between Multiple Headsets

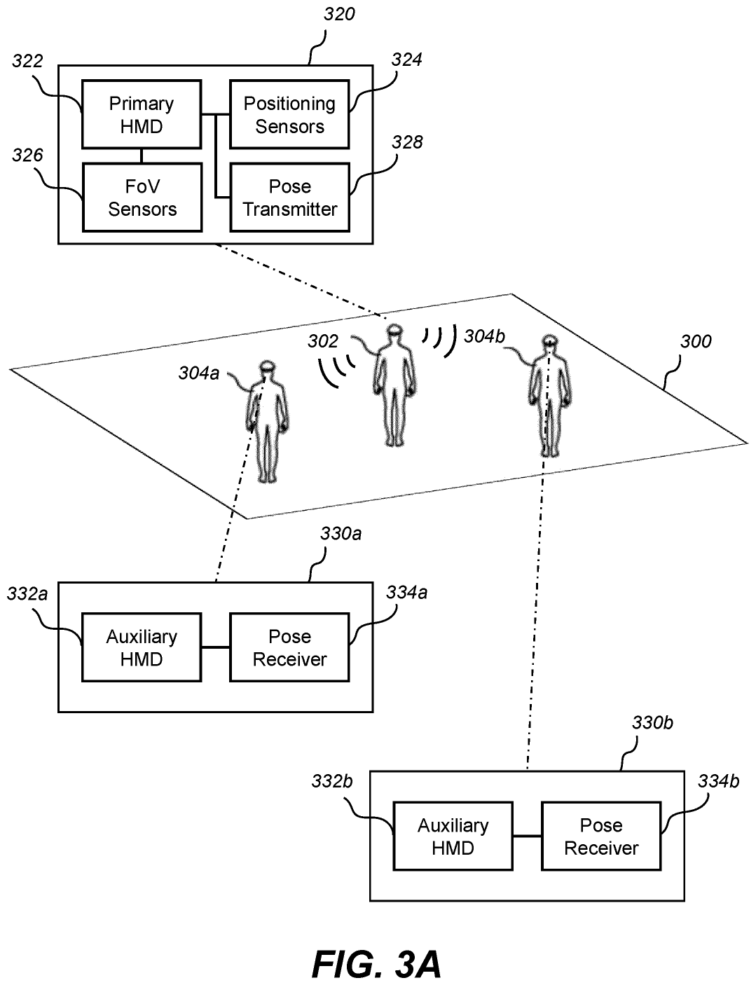

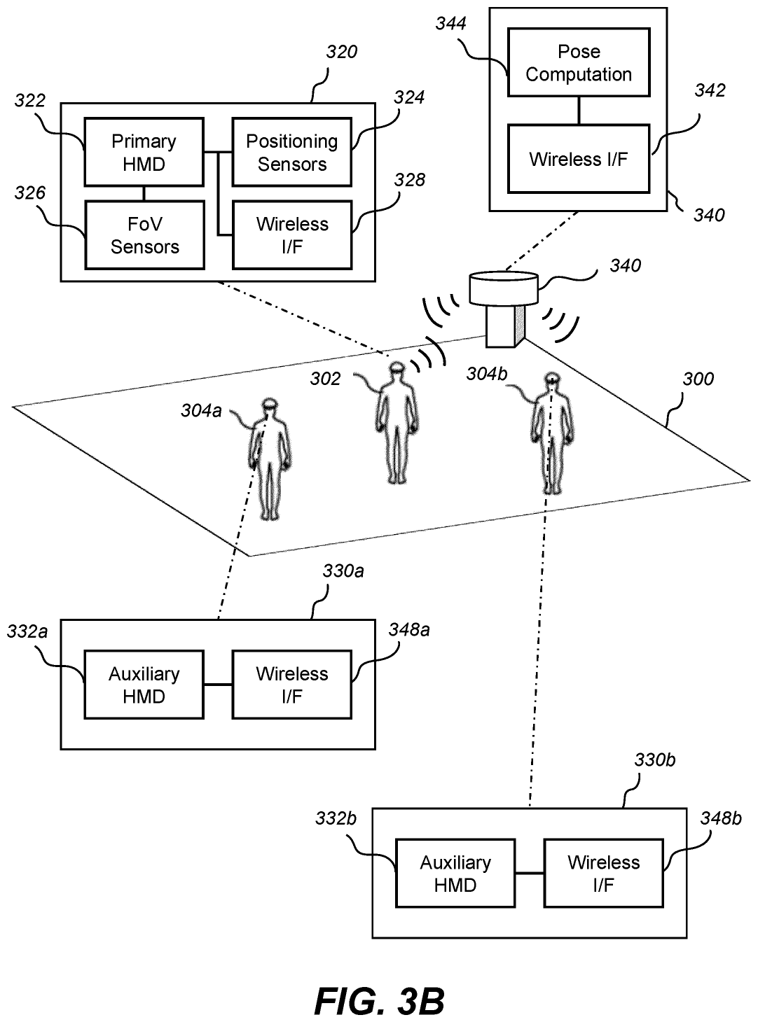

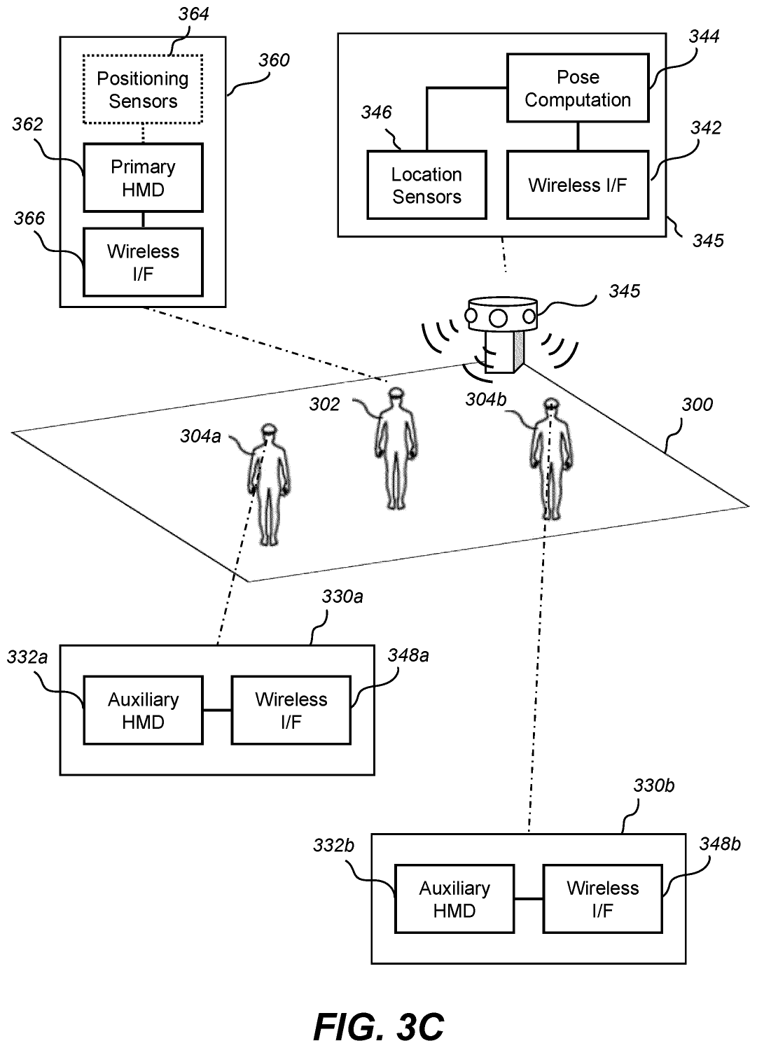

FIGS. 3A to 3C show three different examples of systems for the display of AR information at a construction site. In particular, FIGS. 3A to 3C show how different devices may communicate in order to allow users to view AR information, such as that derived from a BIM. The examples of FIGS. 3A to 3C are compatible with the primary and auxiliary AR headset configurations of FIGS. 2A to 2F, as well as described variations; however, they may also be implemented with headset configurations that differ from the examples of FIGS. 2A to 2F, while retaining functional adaptations to provide the capabilities described with reference to FIGS. 3A to 3C.

In the examples of FIGS. 3A to 3C, there is a system for the display of AR information at a construction site 300. The system comprises a primary positioning device and at least one auxiliary AR headset. The primary positioning device may comprise a static base device or a primary AR headset. The system may comprise a flexible number of auxiliary AR headsets (e.g., from one to a dozen). The system comprises a first set of sensor devices configured to obtain sensor data to determine a pose of the primary positioning device within a coordinate system representing the construction site. These sensor devices may be mounted within or upon the primary positioning device, e.g. they may comprise the sensors 202 and associated electronic circuitry as described with respect to FIG. 2A, a camera-based system for SLAM, or a laser scanning device. The system also comprises a second set of sensor devices configured to obtain sensor data to determine a pose of the at least one auxiliary AR headset relative to the primary positioning device. These may also be mounted within or upon the primary positioning device, e.g. may comprise camera devices 260-A, 260-B in FIG. 2A or the laser scanner 285 in FIG. 2E. In certain cases, at least a portion of the second set of sensor devices may comprise components that are mounted upon hard hats associated with auxiliary AR headsets, such as retroreflectors 292. The system lastly comprises an electronic control system. The electronic control system may form part of the primary positioning device, e.g. be executed by processor 208 in FIG. 2B, or may be located in a remote computing device that is arranged to communicate with one or more of the primary positioning device and the at least one auxiliary AR headset, e.g. by way of a wireless communication channel such as that provided by Bluetooth® and/or based on the IEEE 802.11 family of standards (WiFi®). The electronic control system is configured to: obtain the pose of the primary positioning device and the pose of the at least one auxiliary AR headset relative to the primary positioning device; process the obtained poses to determine a measured pose of said auxiliary AR headset within the coordinate system representing the construction site; and output positioning data for the at least one auxiliary AR headset derived from the measured pose to display AR information via said auxiliary AR headset. Various example implementations of these system will now be described in more detail with reference to FIGS. 3A to 3C.

FIG. 3A shows an example where a first user 302 wears a primary AR headset 320 and two further users 304a and 304b wear respective auxiliary AR headsets 330a and 330b. The primary AR headset 320 comprising a primary head-mounted display (HMD) 322, a set of positioning sensors 324, a set of field-of-view (FoV) sensors 326 and a pose transmitter 328. In this example, the primary AR headset 320 forms the primary positioning device, the positioning sensors 324 form the above first set of sensor devices, and the field-of-view (FoV) sensors 326 comprise the above second set of sensor devices. The positioning sensors 324 may comprise one or more of: the sensors 202 in FIG. 2A, together with associated components shown as part of hard hat 200 in FIG. 2B; one or more camera devices for SLAM based positioning; and one or more active markers for optical tracking. The field-of-view sensors 326 may comprise one or more camera devices as shown in FIG. 2A or the laser scanner 285 shown in FIG. 2E. The positioning sensors 324 provide a pose of the primary AR headset 320. In one case, the pose of the primary AR headset 320 is provided with a high accuracy (e.g., millimetre accuracy). The primary head mounted display 322 may comprise the AR glasses 250 as described with reference to FIGS. 2A to 2F.

In FIG. 3A, each auxiliary AR headset 330 comprises an auxiliary head mounted display 332 and a pose receiver 334. The auxiliary head mounted display 332 may also comprise the AR glasses as described with reference to FIGS. 2A to 2F. In certain examples, the auxiliary head mounted display 332 may differ from the primary head mounted display 322, e.g. the auxiliary head mounted display 332 may comprise a lower cost and/or lower functionality AR device. The pose transmitter 328 and the pose receiver 334 are complementary and are configured in FIG. 3A to exchange data over a wireless communication channel (e.g., such as Bluetooth®, Zigbee®, WiFi® or the like).

In use, the primary AR headset 320 is located within the construction site 300 using the positioning sensors 324. This allows a pose of the primary AR headset 320 within a coordinate system representing the construction site to be determined. This may be a geographic coordinate system that matches an extrinsic coordinate system that is used to define the BIM. The pose of the AR headset 320 may be mapped between coordinate systems for a positional tracking system (associated with positioning sensors 324) and for the BIM using calibrated transformations (e.g., as described in more detail in WO2019/048866 A1, PCT/EP2022/052532 and PCT/EP2022/058383, each of which is incorporate by reference herein). The field-of-view sensors 326 are then used to determine positions of one or more of the hard hats and users 304 associated with the auxiliary AR headsets 330 (e.g., the hard hats worn by users 304 or the faces of users 304). Using position and/or orientation information obtained using the field-of-view sensors 326, the poses of the auxiliary AR headsets 330 relative to the primary AR headset 320 may be determined. In particular, the positioning sensors 324 of the primary AR headset 320 may be used to determine a pose of the primary AR headset 320 that enables display of AR information derived from a BIM upon the primary head mounted display 322. The poses of the auxiliary AR headsets 330 relative to the primary AR headset 320 may not be suitable initially for the display of AR information derived from a BIM as the poses are defined in a coordinate system with respect to the field-of-view sensors 326 (or the associated auxiliary AR headset location system) and thus their position within the construction site 300 (e.g., an absolute position) is not known. However, as the field-of-view sensors 326 form part of the same device as the positioning sensors 324 (e.g., these may be arranged in a rigid, fixed, or otherwise known relationship), the coordinate system used to define the relative poses of the auxiliary AR headsets 330 may be mapped to either the coordinate system of the positional tracking system associated with the positioning sensors 324 or the extrinsic coordinate system of the BIM (e.g., using a further similar mapping as is used for the pose of the primary AR headset). For example, a first transformation may be defined based on the relative arrangement of the positioning sensors 324 and the field-of-view sensors 326 to map the poses of the auxiliary AR headsets 330 into the same space (i.e., coordinate system) as that used to define the pose of the primary AR headset 320. The poses of all the headsets may thus be defined in a common space and then a mapping between this common space and the extrinsic coordinate system of the BIM may be performed using a calibrated second transformation (e.g., as described using the methods described in one or more of WO2019/048866 A1, PCT/EP2022/052532 and PCT/EP2022/058383).

In the example of FIG. 3A, a pose in the coordinate system using by the primary positioning device (e.g., either in the extrinsic coordinate system or the coordinate system of the positional tracking system) of each auxiliary AR headset is transmitted via the pose transmitter 328 to the pose receivers 334. This may comprise a broadcast transmission to all pose receivers 334 with the poses for all auxiliary AR headsets and/or a point-to-point transmission to each pose receiver 334 with specific pose information for the corresponding auxiliary AR headset. The received poses may then be used by the auxiliary head mounted displays 332 to display AR information (e.g., similar to the manner of display described in WO2019/048866 A1).

The positioning sensors 324 and field-of-view sensors 326 may operate independently and in parallel. They may both be implemented as separate closed systems, thus simplifying the implementation and allowing modular use of different off-the-shelf solutions with possibly differing technologies (e.g., the former being part of a high-accuracy tracking system and the latter being part of a lower-complexity and/or accuracy location system). Moreover, each system may be upgraded and/or replaced independently to allow incorporation of new technological developments, such as the incorporation of deep neural network implementations as hardware accelerated and/or fast software implementations improve.

FIG. 3B shows a variation of the example of FIG. 3A. Whereas FIG. 3A shows peer-to-peer communications between the primary and auxiliary AR headsets, FIG. 3B shows an alternative (or complementary) case, where a static control station 340 is provided within the construction site 300 to perform centralised computations. The example of FIG. 3B may be advantageous when a larger number of auxiliary AR headsets are provided and/or in cases where the computational resources of the primary AR headset are limited. The static control station 340 may be incorporated into a wireless access point or local control hub.

In FIG. 3B, the primary AR headset 320 and the auxiliary AR headsets 330 are configured similarly to the example of FIG. 3A. In the case of FIG. 3B, the primary AR headset 320 is provided with a general wireless interface 328 and the auxiliary AR headsets 330 are also provided with a similar wireless interface 348. For example, the wireless interfaces 328, 348 may be provided by the network interface 276 of the AR glasses 250 shown in FIG. 2B.

In FIG. 3B, the static control station 340 comprises a wireless interface 342 and a pose computation module 344. The wireless interface 342 enables communication with the primary and auxiliary AR headsets 320, 330 (e.g., via the respective wireless interfaces 328, 348). As discussed above the wireless interface may implement any known wireless communication standard (such as Bluetooth®, Zigbee®, WiFi® or the like). In the example of FIG. 3B, the static control station 340 implements the electronic control system described above. In one case, the static control station 340 receives sensor data from the positioning sensors 324 and the field-of-view sensors 326 via the wireless interface 342 The pose computation module 344 is then configured to obtain the pose of the primary positioning device and the pose of the at least one auxiliary AR headset relative to the primary positioning device based on the received sensor data. For example, the pose computation module 344 may receive one or more image or video streams and compute respective poses from those image streams. In one case, the positioning sensors 324 and the field-of-view sensors 326 may comprise a shared or common set of sensor devices such as a 360-degree wide angle camera system or a plurality of wide field of view cameras. In this case, a pose of the primary AR headset 320 may be computed using known SLAM methods whereas poses of the auxiliary AR headsets 330 may be computed using the computer-vision-based approaches described above. In another case, the primary AR headset 320 may determine both its own pose and the relative poses of the auxiliary AR headsets 330 and then transmit these to the static control station 340. In both cases, the static control station 340 processes the obtained poses to determine measured poses of the auxiliary AR headsets 330 within the coordinate system representing the construction site 330. These poses may then be transmitted as positioning data to the auxiliary AR headsets 330 via the respective wireless interfaces. At each auxiliary headset 330, the received poses may be used as per the example of FIG. 3A to display AR information via each respective auxiliary AR headset.

The example of FIG. 3B thus shows an extended distributed computing system for computing AR information for display while using a set of heterogenous AR devices. It should be noted that different functions may be distributed amongst the components of this extended distributed computing system (e.g., amongst the primary AR headset 320, the static control station 340, and the auxiliary AR headsets 330) based on the specifications of the available computing resources and communication channels.

FIG. 3C shows a further variation of the examples of FIGS. 3A and 3B. In FIG. 3C, there are multiple auxiliary AR headsets 330 as per the previous examples. These auxiliary AR headsets 330 are equipped with wireless interfaces as described above. In FIG. 3C, there is also a control station 345 similar to the static control station 340 in FIG. 3B. The control station 345 may be static or moveable (e.g., may be robotic with propulsion systems in the latter case). As per the example of FIG. 3B, the control station 345 comprises a wireless interface 342 and a pose computation module 344. However, in the example of FIG. 3C, the control station 345 forms the primary positioning device as described above. The control station 345 comprises a set of location sensors 346. These may comprise a set of camera devices and/or laser scanning devices. The set of location sensors 346 may implement one or more of the first and second sets of sensor devices described above, i.e. they may be used to determine a pose of the control station 340 within a coordinate system representing the construction site 300 and/or may be used to determine relative poses of one or more of the primary and auxiliary AR headsets 320, 330. For example, the control station 345 may be equipped with one or more of the sensor devices shown in the examples of FIGS. 2A, 2B, and 2F, where the sensor devices are equipped within or upon the control station 345 as opposed to the hard hat 200. The pose estimation module 344 receives data from the set of location sensors 346 and uses this to compute poses compatible with AR information (e.g., a defined BIM). The poses and/or virtual image streams may then be communicated to one or more of the primary and auxiliary AR headsets 320, 330 as described previously.

In the example of FIG. 3C, an adapted primary AR headset 360 is shown. In this case, the primary AR headset 360 may be provided in the form of the auxiliary AR headsets 330. In certain cases, the distinction between primary and auxiliary AR headsets is removed as positioning functionality is incorporated into the control station 345, e.g. all headsets are “auxiliary AR headsets”. In certain cases, as shown by the dashed lines, a primary AR headset 360 may be retained with positioning sensors 364 for a positional tracking system similar to positioning sensors 324. In these cases, the positioning data may be communicated from the primary AR headset 360 to the pose computation module 344 of the control station 345 for pose estimation. In certain cases, data from the positioning sensors 364 may be fused with data from the location sensors 346 to improve the pose estimates of all the headsets. For example, a 6D pose of the primary AR headset 360 may be provided along with data generated by location sensors 346 and this may be processed by a trained deep neural network architecture, such as a convolution neural network, that additionally receives the 6D pose as an input together with frames of one or more video streams. In other examples, the locations sensors 346 may comprise the laser scanner 285 shown in FIG. 2E, and the headsets 330, 360 may be equipped with retroreflectors as shown in FIG. 2F, to enable the poses of the headsets to be determined. In certain cases, a first set of sensors for determining a pose of the control station 345 may comprise Global Positioning System (GPS) sensors (or sensors for an equivalent geolocation system). In other cases, the first set of sensors may comprise one or more camera devices that are configured to capture images featuring markers having a known position (e.g., similar to the cases described in one or more of US 2016/292918 A1 and PCT/EP2022/058383) and thus determine a pose with respect to these markers that may be used to determine a pose of the control station 345 with respect to the extrinsic coordinate system of the BIM.

It should be noted that the precise form of the information that is communicated between the headsets shown in FIGS. 3A to 3C may vary based on the implementation. For example, a pose in the coordinate space of the BIM may allow AR information to be computed using BIM data received by each auxiliary AR headset 330. Alternatively, a BIM may be transformed into the coordinate space of the positional tracking system for the primary positioning device at the primary positioning device (e.g., a primary AR headset) and at least portions of the transformed BIM transmitted from the primary positioning device to the auxiliary AR headsets. In yet another case, virtual images comprising AR (e.g., BIM) information aligned with poses in the coordinate space of the positional tracking system may be computed for each headset (i.e., including the auxiliary AR headsets) at the primary positioning device and communicated to individual headsets. This may be of merit where the primary positioning device has additional computational resources and/or configured hardware and/or software components for composing virtual images. In this case, the primary positioning device may stream static or dynamic virtual images (e.g., an AR video stream in the latter case) to individual auxiliary AR headsets. Different approaches may be taken based on available computation resources in the set of headsets and/or the available bandwidth for communication between devices. In certain examples, a wired coupling between headsets may be provided so as to allow higher speed AR video bit rates (although IEEE 802.11ax may allow for GB/s communication speeds).

### Example Methods

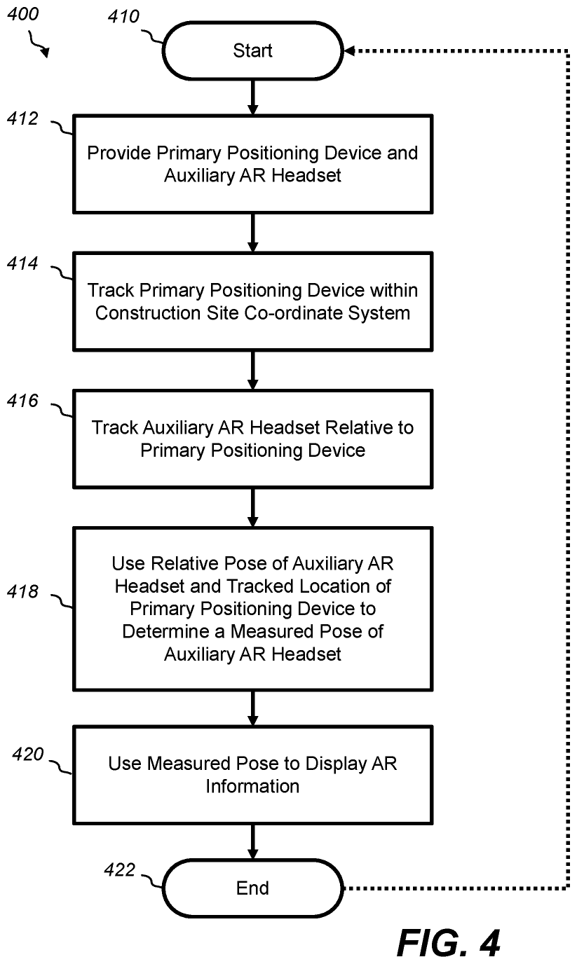

FIG. 4 shows an example method 400 of displaying augmented reality (AR) information at a construction site. The method 400 may be performed using any of the equipment and systems described in any of the previous examples.

The method 400 starts at block 410. At block 412, the method 400 comprises providing a primary positioning device and at least one auxiliary AR headset at the construction site. For example, this may comprise providing a primary AR headset as shown in one or more of FIGS. 2A, 2B, 2E, or 3A to 3C and one or more auxiliary AR headsets as shown in one or more of FIGS. 2B, 2C, 2D, 2F, or 3A to 3C. The term “providing” may refer to supplying users with equipment configured as per the previous examples. The primary positioning device and at least one auxiliary AR headset may then be activated as users explore the construction site.

At block 414, the method 400 comprises tracking the primary positioning device within the construction site using a positional tracking system. The positional tracking system provides a measured pose (i.e., position and orientation) of the primary positioning device within a coordinate system representing the construction site. The primary positioning device may comprise a set of sensor devices, such as photodiodes, camera devices, or active optical markers, for tracking. The coordinate system representing the construction site may comprise a coordinate system for the positional tracking system (e.g., with an origin at a designated base station 102 or at a centroid of a hard hat associated with a primary AR headset) and the pose may comprise a coordinate representing a position within this coordinate system and a normal or set of rotation values representing a viewing direction or object orientation.

At block 416, the method 400 comprises tracking the at least one auxiliary AR headset relative to the primary positioning device. This may involve one or more camera devices as described with reference to FIGS. 2A to 2D and/or one or more laser scanning devices as described with reference to FIGS. 2E and 2F. In one case, the at least one auxiliary AR headset is tracked by detecting a hard hat or set of visual markers of a known configuration in one or more images captured by the primary positioning device, such that a pose of the at least one auxiliary AR headset relative to the primary positioning device (e.g., a camera of said device) may be determined (e.g., using an PNP solver). In another case, a set of positions on a hard hat associated with the at least one auxiliary AR headset may be determined with a laser scanning device mounting upon the primary positioning device, and these positions may be used to determine a pose of the at least one auxiliary AR headset relative to the primary positioning device (e.g., a laser scanner of said device).

At block 418, the relative pose of said auxiliary AR headset and the measured pose of the primary positioning device are then used to determine a measured pose of said auxiliary AR headset within the coordinate system representing the construction site (e.g., absolute with respect to the coordinate system of block 414). For example, this may be performed using a transformation representing the fixed geometric relationship between a camera or scanner origin (e.g., a coordinate system used to define the relative pose) and an origin for the coordinate system used to represent the measured pose of the primary positioning device (e.g., the transformation may comprise a translation and rotation that maps the camera or scanner origin to the positional tracking system origin).

At block 420, the measured pose of at least the at least one auxiliary AR headset is used to display AR information via said auxiliary AR headset. For example, the measured pose may be further transformed to map to an extrinsic coordinate system used by the BIM or BIM data may be transformed to map to the coordinate system of the positional tracking system (either approach may be used, as long as the pose and the AR information are represented in the same coordinate system). The AR information may be generated by mapping a view of the BIM onto a current view as determined from the measured pose of at least the at least one auxiliary AR headset. AR information may be displayed as a virtual image using AR glasses similar to AR glasses 250.

At block 422, the method ends 400. However, in preferred implementations the method 400 is repeated (e.g., as indicated by the dashed line), such that the measured pose of the auxiliary AR headset is continuously updated.

In certain implementations, the primary positioning device comprises one or more camera devices. These may be camera devices with a wide-angle field of view or 360-degree field of view. Example implementations using camera devices as described with reference to FIGS. 2C and 2D.

In certain implementations, the primary positioning device comprises a laser scanner configured to generate a point-cloud representation of the construction site, wherein determining a pose of said auxiliary AR headset relative to the primary positioning device comprises determining a pose of said auxiliary AR headset relative to the primary positioning device using the point-cloud representation of the construction site. For example, the laser scanner may form part of the laser scanner 285 or the location sensors 346.

In certain implementations, the primary positioning device comprises a primary AR headset, wherein the primary AR headset and the at least one auxiliary AR headset are provided to a plurality of users at the construction site, and wherein the measured poses of the primary and auxiliary AR headsets are used to display AR information to said users via respective headsets. In certain implementations, the primary and auxiliary AR headsets are incorporated into hard hats for the construction site, i.e. are provided together with the hard hat as shown in FIGS. 2A to 2F. As hard hats may be selected to have a standardised shape and/or size, this may simplify visual tracking methods for determining the pose of a set of auxiliary AR headsets, e.g. as each user is wearing an item of known dimensions and geometry.

In certain implementations, the method comprises determining a location and orientation of the auxiliary AR headset using one or more camera devices communicatively coupled to the primary AR headset, wherein the primary device comprises a set of sensors for the positional tracking system and the one or more camera devices are mounted in a known spatial relationship to the set of sensors. For example, this is shown in FIG. 2A. In this case, determining a location and orientation of the auxiliary AR headset using one or more camera devices may comprise: capturing one or more images of the construction site using the one or more camera devices; detecting, within said captured images, a marker mounted in a known spatial relationship to the auxiliary AR headset; determining a location of the marker from at least one of the one or more camera devices and an orientation of the marker with respect to said at least one of the one or more camera devices; and using dimensions of the known spatial relationships and the determined location and orientation of the marker to determine the location and orientation of the auxiliary AR headset. For example, this is described with reference to the example of FIG. 2D.

In certain implementations, the at least one auxiliary AR headset comprises a plurality of auxiliary AR headsets, each of said plurality of auxiliary AR headsets comprising a local positioning device for determining positioning data representing one or more of a position and an orientation of the auxiliary AR headset. In this case, the method may further comprise obtaining positioning data from the local positioning devices of the plurality of AR headsets; and processing the positioning data and the measured poses of said auxiliary AR headset within the coordinate system representing the construction site to optimise said measured poses. For example, the local positioning device comprises a simultaneous location and mapping (SLAM) system. In this case, each auxiliary AR headset may be fitted with a lower resolution and/or low-cost RGB or RGB-D camera. Each auxiliary AR headset may thus perform a local SLAM method to determine an approximate local pose. This may then be optimised together with the pose of the auxiliary AR headset derived from the primary positioning system. In another case, the local positioning device may comprise one or more camera devices configured to capture images of one or more visual markers located at the construction site, wherein the visual markers are used to determine the positioning data.

In certain implementations, the at least one auxiliary AR headset exchanges data with the primary positioning device using a wireless communications channel. For example, this is described with reference to FIGS. 3A to 3C.

In certain examples described herein, functions and/or methods may be implemented by a processor (such as processor 208 and/or processor 268) that is configured to load instructions stored within storage device (such as storage device 211 and/or 271 and/or other networked storage devices) into memory (such as memory 210 and/or 270) for execution. In use, the execution of instructions, such as machine code and/or compiled computer program code, by one or more of processors implement the functions and/or methods described herein. Although the present examples are presented based on certain local processing, it will be understood that functionality may be distributed over a set of local and remote devices in other implementations, for example, by way of network interfaces. Computer program code may be prepared in one or more known languages including bespoke machine or microprocessor code, C, C++ and Python.

If not explicitly stated, all of the publications referenced in this document are herein incorporated by reference. The above examples and embodiments are to be understood as illustrative. Further examples and embodiments are envisaged. Although certain components of each example and embodiment have been separately described, it is to be understood that functionality described with reference to one example or and embodiment may be suitably implemented in another example or and embodiment, and that certain components may be omitted depending on the implementation. It is to be understood that any feature described in relation to any one example or and embodiment may be used alone, or in combination with other features described, and may also be used in combination with one or more features of any other of the examples or and embodiments, or any combination of any other of the examples or and embodiments. For example, features described with respect to the system components may also be adapted to be performed as part of the described methods. Furthermore, equivalents and modifications not described above may also be employed without departing from the scope of the invention, which is defined in the accompanying claims.

1. A method of displaying augmented reality (AR) information at a construction site, comprising:
providing a primary positioning device and at least one auxiliary AR headset at the construction site;
tracking the primary positioning device within the construction site using a positional tracking system, the positional tracking system providing a measured pose of the primary positioning device within a coordinate system representing the construction site;
tracking the at least one auxiliary AR headset relative to the primary positioning device, including determining a pose of said auxiliary AR headset relative to the primary positioning device;
using the pose of said auxiliary AR headset and the measured pose of the primary positioning device to determine a measured pose of said auxiliary AR headset within the coordinate system representing the construction site; and
using the measured pose of at least the at least one auxiliary AR headset to display AR information via said auxiliary AR headset,
wherein the primary positioning device comprises a primary AR headset, wherein the primary AR headset and the at least one auxiliary AR headset are provided to a plurality of users at the construction site, and wherein the measured poses of the primary and auxiliary AR headsets are used to display AR information to said users via respective headsets.

2. The method of claim 1, wherein the primary positioning device comprises one or more camera devices.

3. The method of claim 2, wherein the primary positioning device comprises one or more camera devices with a wide-angle field of view.

4. The method of claim 3, wherein the primary positioning device comprises one or more camera devices with a 360-degree field of view.

5. The method of claim 1, wherein the primary positioning device comprises a laser scanner.

6. The method of claim 1, wherein the primary and auxiliary AR headsets are incorporated into hard hats for the construction site.

7. The method of claim 1, comprising:
determining a location and orientation of the auxiliary AR headset using one or more camera devices communicatively coupled to the primary AR headset, wherein the primary device comprises a set of sensors for the positional tracking system and the one or more camera devices are mounted in a known spatial relationship to the set of sensors.

8. The method of claim 7, wherein determining a location and orientation of the auxiliary AR headset using one or more camera devices comprises:
capturing one or more images of the construction site using the one or more camera devices;
detecting, within said captured images, a marker mounted in a known spatial relationship to the auxiliary AR headset;
determining a location of the marker from at least one of the one or more camera devices and an orientation of the marker with respect to said at least one of the one or more camera devices; and
using dimensions of the known spatial relationships and the determined location and orientation of the marker to determine the location and orientation of the auxiliary AR headset.

9. The method of claim 1, wherein the at least one auxiliary AR headset comprises a plurality of auxiliary AR headsets, each of said plurality of auxiliary AR headsets comprising a local positioning device for determining positioning data representing one or more of a position and an orientation of the auxiliary AR headset, the method further comprising:
obtaining positioning data from the local positioning devices of the plurality of AR headsets; and
processing the positioning data and the measured poses of said auxiliary AR headset within the coordinate system representing the construction site to optimise said measured poses.

10. The method of claim 9, wherein the local positioning device comprises a simultaneous location and mapping (SLAM) system.

11. The method of claim 9, wherein the local positioning device comprises one or more camera devices configured to capture images of one or more visual markers located at the construction site, wherein the visual markers are used to determine the positioning data.

12. The method of claim 1, wherein the at least one auxiliary AR headset exchanges data with the primary positioning device using a wireless communications channel.

13. A system for the display of augmented reality (AR) information at a construction site, comprising:
a primary positioning device;
a first set of sensor devices configured to obtain sensor data to determine a pose of the primary positioning device within a coordinate system representing the construction site;
at least one auxiliary AR headset;
a second set of sensor devices configured to obtain sensor data to determine a pose of the at least one auxiliary AR headset relative to the primary positioning device;
an electronic control system configured to:
obtain the pose of the primary positioning device and the pose of the at least one auxiliary AR headset relative to the primary positioning device;
process the obtained poses to determine a measured pose of said auxiliary AR headset within the coordinate system representing the construction site; and
output positioning data for the at least one auxiliary AR headset derived from the measured pose to display AR information via said auxiliary AR headset,
wherein the primary positioning device comprises a primary AR headset, wherein the pose of the primary positioning device is used to display AR information via said primary AR headset.

14. The system of claim 13, wherein the first and second set of sensors devices and the primary AR headset are mounted with respect to a hard hat for a first user.

15. The system of claim 13, wherein the second set of sensor devices comprises one or more of a wide-angle camera system and an electronic distance measurement device.

16. The system of claim 15, wherein the system comprises:
an electromagnetic tracking system, and
wherein the first set of sensor devices comprise a set of receivers for an electromagnetic tracking system.

17. A non-transitory computer-readable storage medium storing instructions which, when executed by at least one processor, cause the at least one processor to:
provide a primary positioning device and at least one auxiliary AR headset at the construction site;
track the primary positioning device within the construction site using a positional tracking system, the positional tracking system providing a measured pose of the primary positioning device within a coordinate system representing the construction site;
track the at least one auxiliary AR headset relative to the primary positioning device, including determining a pose of said auxiliary AR headset relative to the primary positioning device;
use the pose of said auxiliary AR headset and the measured pose of the primary positioning device to determine a measured pose of said auxiliary AR headset within the coordinate system representing the construction site; and
use the measured pose of at least the at least one auxiliary AR headset to display AR information via said auxiliary AR headset,
wherein the primary positioning device comprises a primary AR headset, wherein the primary AR headset and the at least one auxiliary AR headset are provided to a plurality of users at the construction site, and wherein the measured poses of the primary and auxiliary AR headsets are used to display AR information to said users via respective headsets.

18. The medium of claim 17, wherein the instructions which, when executed by at least one processor, cause the at least one processor to:
determine a location and orientation of the auxiliary AR headset using one or more camera devices communicatively coupled to the primary AR headset, wherein the primary device comprises a set of sensors for the positional tracking system and the one or more camera devices are mounted in a known spatial relationship to the set of sensors,
wherein the at least one processor is instructed to:
capture one or more images of the construction site using the one or more camera devices;
detect, within said captured images, a marker mounted in a known spatial relationship to the auxiliary AR headset;
determine a location of the marker from at least one of the one or more camera devices and an orientation of the marker with respect to said at least one of the one or more camera devices; and
use dimensions of the known spatial relationships and the determined location and orientation of the marker to determine the location and orientation of the auxiliary AR headset.

19. The medium of claim 17,
wherein the at least one auxiliary AR headset comprises a plurality of auxiliary AR headsets, each of said plurality of auxiliary AR headsets comprising a local positioning device for determining positioning data representing one or more of a position and an orientation of the auxiliary AR headset, wherein the instructions which, when executed by at least one processor, cause the at least one processor to:
obtain positioning data from the local positioning devices of the plurality of AR headsets; and
process the positioning data and the measured poses of said auxiliary AR headset within the coordinate system representing the construction site to optimise said measured poses,
wherein the local positioning device comprises one or more of:
a simultaneous location and mapping (SLAM) system; or
one or more camera devices configured to capture images of one or more visual markers located at the construction site, wherein the visual markers are used to determine the positioning data.

20. The medium of claim 17, wherein the primary positioning device comprises one or more of:
one or more camera devices;
one or more camera devices with a wide-angle field of view;
one or more camera devices with a 360-degree field of view; or
a laser scanner.
